(19) United States
(12) Patent Application Publication
(10) Pub. No.: US 2017/0131948 A1
(43) Pub. Date: May 11, 2017

(54) Visualization of usage impacts on solid state drive life acceleration

(71) Applicant: Virtium LLC, Rancho Santa Margarita, CA (US)

(72) Inventors: Pho Hoang, Rancho Santa Margarita, CA (US); Phu Pham, Rancho Santa Margarita, CA (US); Hoang Pham, Rancho Santa Margarita, CA (US)

(21) Appl. No.: 15/050,448

(22) Filed: Feb. 22, 2016

Related U.S. Application Data
(63) Continuation-in-part of application No. 15/011,457, filed on Jan. 29, 2016.
(60) Provisional application No. 62/252,418, filed on Nov. 6, 2015.

(51) Int. Cl. G06F 3/06

(52) U.S. Cl. CPC G06F 3/0653; G06F 3/0616; G06F 3/0679

(57) ABSTRACT

Properties of a solid state drive can be shown in a visual representation, which includes aspects of the solid state drive, such as remaining lifetime, read and write workload, life acceleration characteristics, and temperature correlation of data and errors.

The present application claims priority from U.S. Provisional Patent Application Ser. No. 62/252,418, filed on Nov. 6, 2015 entitled: “Data and collection methods to analyze life acceleration of SSD with real usages” (VIR013-PRO), which is incorporated herein by reference.

The present application is a continuation-in-part of application Ser. No. 15/011,457 filed on Jan. 29, 2016, entitle: “Data and collection methods to analyze life acceleration of SSD with real usages” (VIR013), which claims priority of U.S. Provisional Patent Application Ser. No. 62/252,418, filed on Nov. 6, 2015, entitled: “Data and collection methods to analyze life acceleration of SSD with real usages” (VIR013-PRO), which is hereby incorporated by reference in its entirety.

### BACKGROUND

The present invention generally relates to improvements in storage devices, and in particular to storage devices using flash memories as a storage medium.

Random access nonvolatile storage media such as magnetic disks have been used as the data storage media. For example, re-writable high capacity storage devices include hard disk drives.

In recent years, various erasable nonvolatile semiconductor memory devices have been developed, called solid state drives, which include flash memory devices. Solid state drives can be low cost, low power consumption, and fast access time.

However, flash memories have a reduced number of erase and write operations. Flash memories also must be erased before it can be rewritten. In addition, a block of memory, e.g., a large number of memory cells such as 512 KB including 128 pages at 4 KB per page, must be erased at the same time. This can shorten the life time of the solid state drive due to the limited number of program/erase cycles (p/e cycles) and impact the performance of the solid state drive due to the moving of data for memory block erase.

There is a need for an improved life time and performance for solid state drives.

### SUMMARY OF THE EMBODIMENTS

In some embodiments, the present invention discloses methods and systems for visualizing properties of a storage device, such as the workload, the performance, the life acceleration characteristics, and the changes of these properties as a function of time. The visualization can allow a user to see, at a glance, the history of the drive operation, the trend of the workload, how these factors affect the performance of the storage device, and how to improve the performance of the storage drive.

The visualization can use data from logged data set, e.g., data from a logged data set for a storage device can be used to calculate and display the properties shown in the visualized graphics. The logged data set can include multiple logged data, e.g., attributes of the storage device collected at different times. The time-related recorded information can allow the calculation of the properties of the storage devices having time units, to be displayed in the visualized graphs with time axis.

In some embodiments, the present invention discloses methods and systems to display instantaneous properties, together with accumulative properties. For example, an accumulative value of lifetime can be shown, which can be a remaining lifetime of the storage device. The remaining lifetime can be calculated based on current operation, together with past performance and operation. The remaining lifetime can provide information on how much longer the storage drive can be in operation, based on the current and past performance and operation. An instantaneous value of lifetime can be shown, which can be a lifetime expectancy of the storage device calculated based only on the current operation, and without regard to the past operation. By displaying both properties, the failure date of the storage device can be estimated, together with the knowledge of how the usage of the storage device can affect the performance of the storage device.

In some embodiments, the present invention discloses methods and systems to display important parameters of a storage device at one glance, e.g., in one report. The report can include a visual description of remaining lifetime of the storage device, a visual display of read and write workload, a visual display of life acceleration, e.g., how the usage impacts the storage device, and a visual display of temperature and data write, read and errors.

### BRIEF DESCRIPTION OF THE DRAWINGS

FIG. 1 illustrates a solid state drive and its operation according some embodiments.

FIGS. 2A-2B illustrate solid state drives having logging modules according to some embodiments.

FIGS. 3A-3B illustrate operations of a solid state drive according to some embodiments.

FIGS. 4A-4C illustrate flow charts for forming time or index logged data according to some embodiments.

FIGS. 5A-5C illustrate flow charts for generating an index or time logging process according to some embodiments.

FIGS. 6A-6B illustrate a visualization of life acceleration according to some embodiments.

FIGS. 7A-7B illustrate a visualization of life acceleration according to some embodiments.

FIGS. 8A-8B illustrate flow charts for displaying life acceleration properties according to some embodiments.

FIGS. 9A-9B illustrate a visualization of life acceleration according to some embodiments.

FIGS. 10A-10B illustrate flow charts for displaying life acceleration properties according to some embodiments.

FIGS. 11A-11C illustrate a visualization of life acceleration according to some embodiments.

FIGS. 12A-12C illustrate relationships between attributes of a solid state drive according to some embodiments.

FIG. 13 illustrates a graphic summary of a solid state drive according to some embodiments.

FIGS. 14A-14B illustrate an example of a graphic summary according to some embodiments.

FIG. 15 illustrates a computing environment according to some embodiments.

FIG. 16 is a schematic block diagram of a sample computing environment with which the present invention can interact.

### DETAILED DESCRIPTION OF THE EMBODIMENTS

In some embodiments, the present invention discloses methods, systems, and devices having the methods implemented, for a visual display of parameters, such as displaying workload-related behaviors and characteristics, of storage devices, such as flash memory devices which are commonly called solid state drives (SSD) or solid state disks. A logging module can be added to record the characteristics of the solid state drives as a function of time, e.g., the recording can include a time stamped and/or size indexed. The time characteristics of the storage devices can then be analyzed and displayed, to provide indication and improvement of the performance of the solid state drives.

The analyzed time characteristics of the storage devices can be used to provide an indication of time on the performance of the storage devices, such as the remaining lifetime or the lifetime expectancy. Currently, SSD lifetime tools normally give users a percentage of life remaining or a remaining number of terabytes which can be securely written. For example, an SSD attribute, e.g., an SSD indicator, can show that there is 80% of life remaining, but the information does not tell when the storage drives will need to be replaced. Is it tomorrow, next month, or 10 years from now?

In some embodiments, the present invention can provide a visual behavior of the storage devices as a function of time, thus the remaining time of the storage devices can be read from a graph, together with the lifetime expectancy, e.g., how long can the SSD last with for different usages.

The time graphs of the characteristics of the storage devices can be used to view the effect of different workloads or software programs. For example, the time graphs can show a user how the daily workload can affect the life expectancy and/or performance. For example, when a user subjects the storage drive to a new workload, a new software or firmware, the time graphs of the storage drive will correspondingly show a change in performance and/or life expectancy. The change will allow the user to understand the impact of the storage drive in new situations, such as a new workload, a new firmware, or a new software.

For example, when a user installs new software or changes a software in their system, the usage or workload on a SSD can be changed, which can also change the life expectancy and performance of the storage drive. The time graphs can show the user, at a glance, whether the change has positive or negative impact on the storage drive after a short period of data collection, such as in a few days. The time graphs can offer a big advantage for users evaluating new software, fixing software, or doing system regression tests.

Further, the time graphs can allow a user to trace a sudden change in performance of the storage drive. For example, when the user experiences a sudden drop in performance, the time graphs can show the user the time when the change starts, and the user can identify the events that cause the damages.

In some embodiments, the present method can use real data, e.g., when the user is using the storage drive in the system, to calculate the time characteristics of the storage drive. For example, the method can provide a way to calculate life expectancy of the storage drive based on real usage. Thus the method can offer a more accurate life expectancy and performance to the user, for example, as compared to modeling of workload data when calculating life expectancy.

In some embodiments, the present method can obtain logged data, e.g., attributes related to performance and life acceleration data, in SMART log, including data writes, data reads, NAND consumption parameters (e.g., NAND erase count or program/erase cycle count), and life remaining percentage. A host system can, while the storage drive is in use, read the SMART attributes, e.g., indicators generated by the SMART program or system, and log the data periodically. The host can also add index and time stamp for each data log, thus creating a logged data set of the storage drive.

In some embodiments, the present method can assist a user in visualizing life expectancy in a timing sense, e.g., the drive will die in 3 months with this workload, and 2 years with another workload. From time graphs of the storage drive, a user can know the history, the trend of workloads, and how the workloads can affect the life expectancy of the storage drive.

Solid state drives can have a life expectancy, mainly due to the maximum number of program and erase (program/erase or p/e) cycles that a flash memory can endure. A program/erase cycle can include a process of programming (e.g., writing to a flash memory) and then erasing the flash memory. Similarly, the program/erase cycle can include a process of erasing and then programming a flash memory.

Before writing to a flash memory, the memory will need to be first erased, using one p/e cycle for the memory. Thus the number of program/erase cycles can also be called erase counts, e.g., the number of erases performed on the memory.

The determination of life expectancy can be further complicated since writing can be performed on a page of memory, instead of just one byte. In addition, erasing operation can only be performed on a block, which can be 16-128 pages.

Thus, in a worst case scenario, rewriting one byte can force rewriting a page, which can be 1-4 Kbytes. Since the memory will need to be erased before rewriting, rewriting one byte can force erasing one block, thus consuming up to 512,000 p/e cycles, since a block of 512 Kbytes of memory can be erased to prepare for writing the one byte of data. Clever mapping algorithms had been developed to alleviate this issue. However, a certain amount of write amplification is always unavoidable.

In some embodiments, the present invention discloses a time-based workload logging feature for monitoring the workload of a solid state drive, which can be used to predict the life expectancy of the solid state drive, for example, through the consumption of p/e cycles. The workload logging feature can provide an indication of how long the drive will last, e.g., how fast the drive life will go down based on the current workload. Further, the workload logging feature can also provide changes in the predicted life expectancy when the workload is changed.

The correlation and calculation of the life expectancy of a solid state drive are based on actual usage, e.g., the logged workloads, of the solid state drive while the solid state drive is being used. This is in contrast to model data, or data that is generic to all workloads, and thus not really suitable for the particular workload that the current solid state drive is experiencing. Hence, it will give the most accurate life expectancy data to the user. The method can also provide the user with the history, trend, sense of timing on life expectancy, and sense of workloads in their system.

In some embodiments, the present invention discloses storage devices with time-based workload logging features, and methods and systems to implement the storage devices. The storage devices can include solid state devices which have flash memory packages connected to a controller.

Solid state devices utilize solid state memory arrays, thus there are no mechanical moving parts, leading to potential higher reliability. In addition, the memory arrays can be configured to allow parallel processing, leading to potential faster access time.

The solid state memory arrays can include flash memory devices, which differ from other forms of memory storage since the flash memory devices cannot be overwritten without first being erased. Furthermore, the flash memory devices have limited re-writing cycles, thus wear leveling is typically implemented, in which the usage of the flash memory devices are uniformly spread around the solid state drives.

For example, block-level wear leveling can be used by a controller of the flash memory devices to track the erase and write status of various memory blocks. New blocks can be allocated for use to accommodate newly received data, evenly distributing the usage of memory blocks.

To hide the differences of the solid state drives, e.g., the high erase overhead, a memory access abstraction can be implemented, for example, in the flash translation layer. A logical-to-physical address mapping can represent the physical addresses of the flash memory devices with logical addresses, e.g., logical addresses of traditional hard drives, to the application software.

Operations of a flash memory are explained below. A block in a flash memory is a memory unit for collectively erasing data. A page is a memory unit for reading and writing data. A block can have multiple pages. A word is a memory unit for data modification. A page can have multiple words. The flash memory cannot directly rewrite data. The memory will need to be erased before new data can be rewritten at that memory. Thus, in a typical operation, when a new data needs to be rewritten to a word in a block of the flash memory, the stored valid old data in the block is saved, e.g., written, to another block. The old data in the block are erased, and then the new data is written to the erased block. Some algorithms handle this using different techniques of read-modify-writing. For example, the old data can be read into volatile memory buffer. The modified words are updated in memory and then are written to a different NAND location. The mapping structure is then changed to reference the logical address to the new physical address.

Thus the rewriting of data in a flash memory necessitates more writing or erasure compared to the amount needed or intended, which can severely affect the rewriting performance of the flash memory. Thus it can be necessary to write data to a flash memory using an algorithm capable of hiding the time required to erase data from the flash memory. A flash memory also can have limited erasure times, thus a block with excessively high erase count can become unusable since data can no longer be erased from such block. Thus it can be necessary to even the erase counts of the memory blocks.

Flash memory is accessed via a driver, which accepts reads and writes in units of sectors, corresponded to hard drive devices. If the driver writes data directly to the physical sector address, this could require an entire block to be erased during every write process, leading to slow access time and unevenly flash memory wear. Thus, repeated writes of a same data should be written to different physical locations of the flash memory. In other words, the address of a same data would be changed every time the data is rewritten. To present a consistent, e.g., unchanged, data address even though the data is written, logical addresses for the data are introduced, together with a mapping that translates the logical addresses to physical addresses. To the host system, the address of the data is the logical address, which is unchanged no matter how many times it is rewritten. The mapping can handle the address change, e.g., mapping the logical address of the data to different physical addresses in the flash memory every time the data is rewritten.

Thus an address mapping process and table, which translates logical addresses to physical addresses, is performed in the flash memory module upon writing data. A controller can be used to provide a logical address to an external host or processor, and also provide a physical address with respect to the solid state drive. The controller can manage the solid state drive using the physical addresses, and can convert the physical addresses into the logical addresses. A layer, e.g., an abstract concept of solid state drive partitions, in which logical addresses and physical addresses are converted from each other are typically referred to as a flash translation layer (FTL).

A solid state drive can be coupled to a host system, which interfaces with the solid state drive as though it were a hard disk drive. The solid state drive can contain a mapping table for mapping to addresses, e.g., converting between logical and physical addresses. The mapping table can be stored in the solid state drive on random access memory (RAM). The mapping table can be generated upon initialization, such as when it is connected to the host system. The mapping table can be lost when power is removed, such as when it is removed from the host system. Thus upon initialization, the solid state drive can be scanned to generate the mapping table. Some algorithms implement ways to preserve the mapping table to some extent across power lost in order to optimize the mapping table reconstruction process.

The FTL can use an address mapping table to perform a rapid address mapping operation, for example, RAM or static random access memory (SRAM). Using the address mapping function of the FTL, a host system can recognize the solid state drive as a hard drive, and can access the solid state drive in the same manner as the hard disk. The FTL can be included in the solid state drive and independent to the host system.

The address mapping methods can include a page-level address mapping method, a block-level address mapping method, and a hybrid address mapping method. In the page-level address mapping method, the unit of the mapping table is commonly page unit size, meaning a logical page of data is converted into a physical page. In the case of a block-level address mapping method, the unit of the mapping table is commonly block unit size, meaning a logical block of data is converted into a physical block.

Page-level address mapping can provide good performance due to address conversion with greater accuracy, but it can be expensive due to the large size requirement of the address mapping table. Block-level address mapping requires smaller size, but it can be expensive to manage because it must erase and update a whole data block even when a single page in the block is changed.

In the case of a hybrid mapping method, the mapping table can be either page unit or block unit size, such as using a page-level address mapping method over a log block and a block-level address mapping method over a data block. In some cases, fine grained page mapping can be reserved for data that is changed frequently, while block mapping can be reserved for data that are changed less frequently.

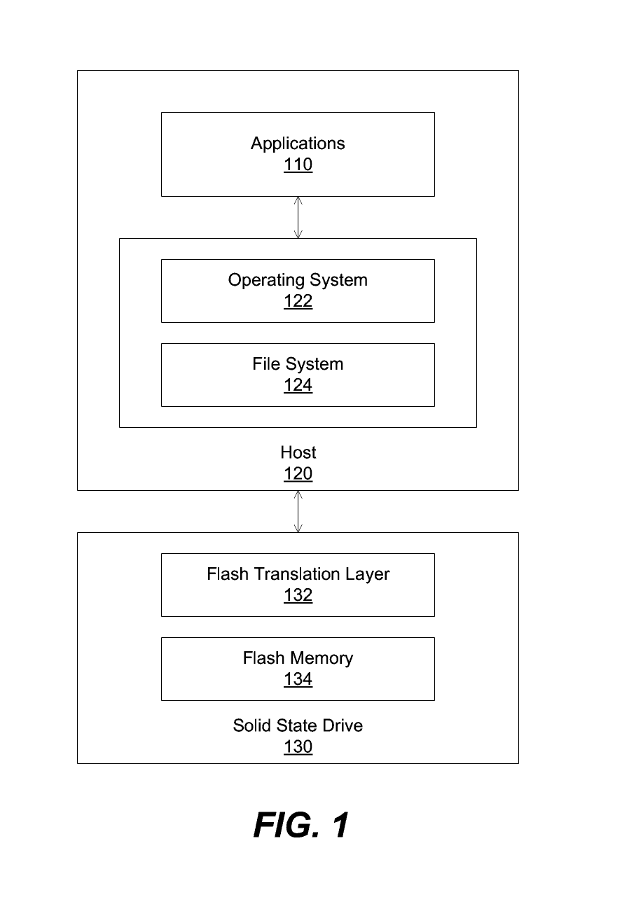

FIG. 1 illustrates a solid state drive and its operation according some embodiments. A solid state drive 130 is coupled to a host system 120, such as a computer or a data processing system. The solid state drive 130 can include a flash memory 134. The flash memory 134 can include a set of flash memory packages, with each memory package having one or more dies. Each die can have multiple planes, which have many blocks, with each block having multiple pages.

The flash memory 134 can be connected to a controller for managing the memory. For example, the controller can include a host interface logic for communicating with the host 120, logic, memory buffer, and flash demux/mux to access the flash memory 134, optional memory such as RAM (read-write memory) for potential application software, and a flash translation layer 132.

The controller can utilize firmware, e.g., application software for the solid state drive 130, for many functions instead of hardware, for example, to reduce the cost of the solid state drives. For example, the firmware can include a flash translation layer mapping, which can map the physical addresses of the memory 134 to logical addresses that the host 120 requires. The flash translation layer mapping, e.g., a software loaded to the flash translation layer 132, can hide the characteristics of the flash memory 134, and can present the flash memory 134 under a file system 124 to the host 120, such as file systems utilized by hard drives.

The host 120 can include an operating system 122, such as Windows operating system or MAC operating system. The operating system 122 can be configured to recognize various file systems 124, such as FAT, NTFS, file systems used by Linux, or file systems used by MAC OS. The flash translation layer mapping, resided in the flash translation layer 132, can translate the characteristics of the file system 124 to the characteristics of the flash memory 134, allowing the host system 120, e.g., the applications 110 run by the host 120, to access the solid state drives without any knowledge of the internal structures and behaviors of the solid state drives. Thus despite the complexity and differences of the solid state drives, through the flash translation layer, the host system can view the solid state drive as a hard drive, with the characteristics indicated by the file system 124.

The above description is overly simplified in order to illustrate the function of the flash translation layer or the logical-to-physical address mapping table. In practice, the flash memory at physical address might need to be erased by erasing a whole block containing the physical sector. Garbage data collection and wear leveling mechanisms also need to be implemented.

For example, a complete sequence of an out-of-place write can include choosing a free flash memory page, then writing the new data to it, followed by invalidating the previous version of the page involved, and then updating the logical-to-physical address map to reflect the address change. Thus the controller of the solid state drive can maintain a data structure for the pool of free flash memory blocks in which data can be written. The data pages of the free flash memory blocks can be allocated to the write requests can be dictated by a data placement function responsible for wear leveling, for example. The out-of-place write operation thus requires a garbage collection routine to reclaim invalid pages dispersed in flash memory blocks, copying valid pages out of the memory block, then erasing the block and adding the erased block to the pool of free blocks.

In some embodiments, the present invention discloses methods and systems for assisting in operating a solid state drive, including providing time-related information of the solid state drive, thus providing performance and life data based on events to the solid state drive. The event characteristics can allow possible improvements, for example, by evaluating the software updates applied to the solid state drive. Actual workloads of the solid state drive can be used to provide information related to the characteristics of the solid state drive, such as life time expectancy and performance of the drive. In addition, the event related characteristics of the solid state drive can be used in routines called by the user, which can indicate the effectiveness of the updated software. For example, a new software can be evaluated by comparing the new performance and lifetime of the solid state drive with those of the old software.

In some embodiments, the present invention discloses a workload log for a solid state drive. The workload log can be stored in the solid state drive or in the connected host. The workload log can include the attributes of the solid state drive, such as the attributes or indicators in SMART (Self-Monitoring, Analysis and Reporting Technology) log. The workload log can also include summary and/or details of the operation commands. For example, the workload log can include at least one of operation commands, read operations, sizes of read operations, write operations, sizes of write operations, erase operations, garbage collection operation, sizes of garbage collection operations, wear leveling operations, sizes of wear leveling operations, buffer operations, sizes of buffer operations, over provisioning operations, sizes of over provisioning operations, and sequential or random characteristics of read and write operations.

In some embodiments, the attributes or indicators of the solid state drive, such as the read operations, write operations, sizes and frequencies of the operations, and the internal operations, such as the wear leveling process and the garbage collection process, life expectancy and performance, can be recorded. The recorded data can be analyzed in view of the workloads or the software to identify workloads or software with better or worse drive characteristics. The recorded data can also be analyzed to identify algorithms, e.g., garbage collection or wear leveling algorithm, that can improve the drive life time or performance. Information related to the characteristics of the solid state drive, such as projected life time and performance, can be provided, for example, in a visual presentation, to allow a user to understand the solid state drive operations. Improvements to the solid state drive can be suggested and implemented.

In some embodiments, the present invention discloses a logging software for logging operations in a solid state drive. A logging module can include a memory portion for storing the logged data. A logging software, e.g., a program, can be used to log, e.g., record, the operations of the solid state drive. The logging software can be loaded to a controller, such as an operating controller of the solid state drive or a special controller for logging operations. The logging software can be stored in the logging module or can be stored in a memory portion in the solid state drive. The logging software can be a standalone software, running independent of the operating software of the solid state drive. The logging software can be an integrated part of the operating software of the solid state drive, e.g., including subroutines or modules that can be called from the operating software.

The logging software can be configured to record summary and/or details of the operations of the solid state drive, including external operations and internal operations. The logging software can record operation details to the memory module, to the memory block level, to the memory page level, or to the memory cell level. For example, the logging software can record the erase number of each memory block, forming a table of erase counts v. the memory blocks of the solid state drive. The logging software can record the read or write operations on each page or each block. The logging software can also record the number of times the controller used to write a data, e.g., the write amplification characteristic of each write data.

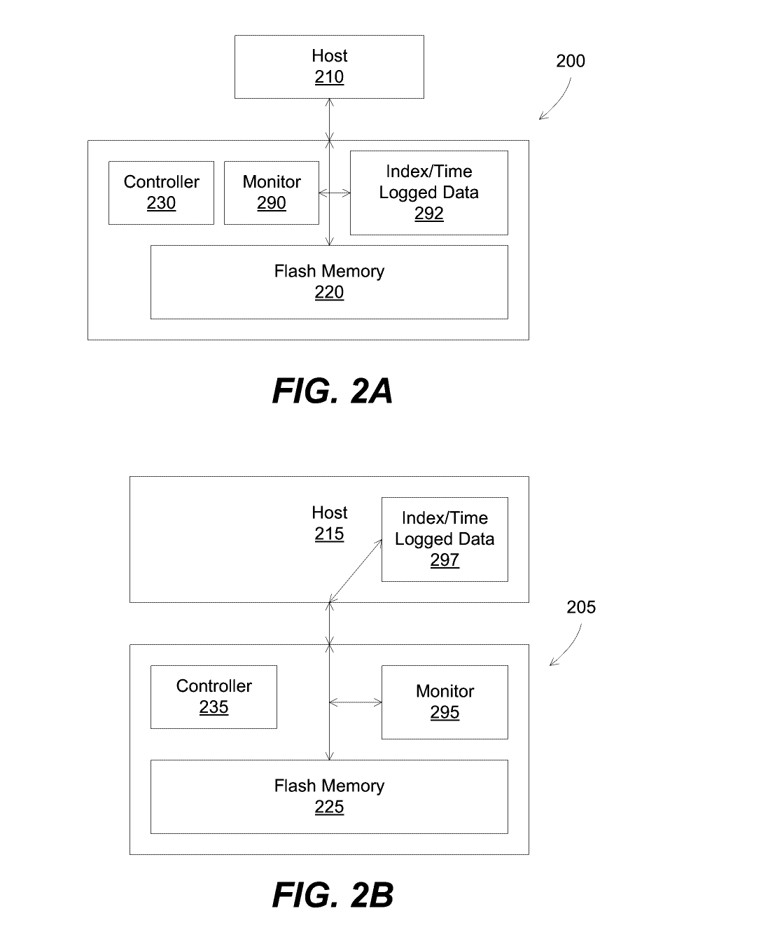

FIGS. 2A-2B illustrate solid state drives having logging modules according to some embodiments. The logging module can include a logging software for performing the data logging, and a memory portion for storing the logged data. The logged data can be stored in the solid state drive or in the host.

In FIG. 2A, a solid state drive 200 can be connected to a host 210. The solid state drive 200 can include flash memory portion 220, together with a controller 230 for operating the solid state drive 200. A monitor program 290, such as a SMART monitoring system, can detect and report the attributes or indicators of the solid state drive 200, for example, for monitoring the drive reliability.

A logging program can be used to periodically record the monitored attributes, e.g., the indicator of the SMART program. The time logged data 292 can be stored in the solid state drive. The time logged data can include the SMART attributes, such as Raw Read Error Rate, Retired Block Count, Power-On Hours, Device Power Cycle Count, Soft Read Error Rate, Gigabytes Erased, Reserve Block Count, Program Fail Count, Erase Fail Count, Unexpected Power Loss, Wear Range Delta, Program Fail Count, Erase Fail Count, Reported I/O Error Detection Code Errors (IOEDC errors), Reported Uncorrectable Errors (URAISE), Temperature, ECC On-the-Fly Error Count, Reallocation Event Count, Uncorrectable Sector Count, SATA R-Errors Error Count, Uncorrectable Soft Read Error Rate (UECC), Soft ECC Correction Rate (UECC), Drive Life Protection Status, SSD Life Left, Available Reserved Space, Power Fail Backup Health, Lifetime Writes from Host System, Lifetime Reads to Host System. The essential parameters can include data writes, data reads, NAND consumption parameters (NAND erase count), and life remaining percentage. Other parameters can provide an indication of performance, such as the temperature of the SSD.

In addition, the logged data can include attributes or indicators of the solid state drive, and details of the internal operations of the solid state drive, such as erase operations, garbage collection operations, wear leveling operations, and other information related to the operations of the solid state drive, such as using the look ahead information, using the buffer information, using the over provisioning memory, moving static data stored in the solid state drive. The logged data can include characteristics of the internal operations, such as the aligned or non-aligned characteristics of the block memory in writing operations, the random characteristics of the read or write data, and the sequential characteristics of the read or write data. In some embodiments, the performance of the solid state drive can also be logged, such as the read and write access times, e.g., the time it takes for returning the read data after receiving a read command, or the time it takes to perform the write operation from the write command. Raw or processed data can be recorded. Alternatively, semi-processed data can be recorded for reducing storage space, such as data can be accumulated and then stored by memory blocks or memory pages, such as block erase/block write, or block erase/page write.

In FIG. 2B, a solid state drive 205 can be connected to a host 215. The solid state drive 205 can include flash memory portion 225, together with a controller 235 for operating the solid state drive 205. A monitor program 295, such as a SMART monitoring system, can detect and report the attributes or indicators of the solid state drive 205, for example, for monitoring the drive reliability.

The attributes generated by the SMART monitoring system 295 can be sent to the host to be stored in a memory portion 297 of the host 215. Similar to the logged data 292, the logged data 297 can include the SMART attributes, the communication with a host, such as read and write operations, together with characteristics of the data associated with the read and write operations. In addition, a host logging can be included, which resides in the host and logs data and commands generated by the host.

In some embodiments, the present invention discloses a software for analyzing and visualizing logged data from a solid state drive. An analyzing/visualizing software, e.g., a program, can be used to analyze the logged workload from the solid state drive, together with displaying the results in a visual presentation that can allow a user to view important parameters of the solid state drive at a glance. The analyzing software can be run from the solid state drive, e.g., the logged data can be analyzed directly from the solid state drive, or from the host, e.g., the logged data can be sent to the host to be analyzed, or if the logged data is already at the host, the host can access and analyze the logged data.

For example, the analyzing software can be loaded to a controller, such as an operating controller of the solid state drive or a special controller for analyzing operations. The analyzing software can be stored in the logging module or can be stored in a memory portion in the solid state drive. The analyzing software can be a standalone software, running independent of the operating software of the solid state drive. The analyzing software can be an integrated part of the operating software of the solid state drive, e.g., including subroutines or modules that can be called from the operating software.

The analyzing software can be loaded to the host, for example, to use the computing power from the host. The analyzing software can retrieve the logged data from the solid state drive for the analysis. Alternatively, the logged data can be sent to the host, for example, by the logging software.

The analyzing software can be configured to assess the operations, for example, to generate data related to a life time expectancy or a performance of the solid state drive. The analyzing software can also be configured to assess the effectiveness of the operating software of the solid state drive. For example, using the stream of data, e.g., read data from the solid state drive and write data to the solid state drive, the behavior of the solid state drive, characterized by the logged data, can be evaluated. Better algorithms can be proposed and installed to the solid state drive to improve the life expectancy or performance of the solid state drive. The improvement is based on actual data, thus the new operating software can be optimized for the actual operation of the solid state drive. For example, a solid state drive can be first implemented with a generally optimized operating software, e.g., an operating software that is optimized for the most common scenario, and not necessarily optimized for the current workload. Using the current workload, the operating software of the solid state drive can be changed to best suit the current workload. The process can be continued, e.g., a new operating software can be implemented when the workload changes.

In some embodiments, the present invention discloses systems and methods to enhance operations of a solid state drive using actual history of the solid state drive. For example, the history of the solid state drive can be logged by a logging module of the solid state drive, which can be analyzed to obtain the characteristics of the solid state drive, and which can be displayed for quick assessments from a user.

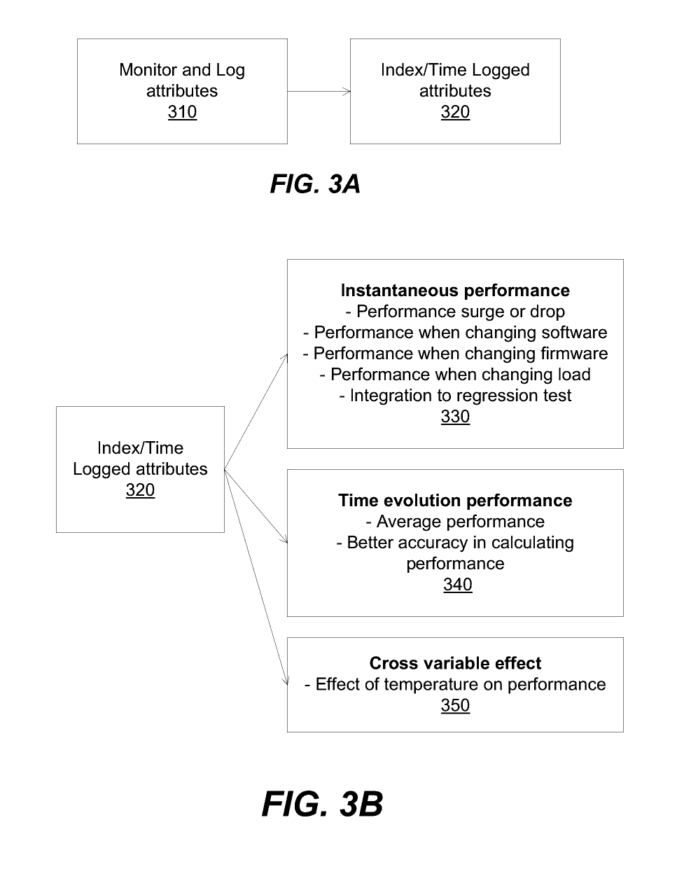

FIGS. 3A-3B illustrate operations of a solid state drive according to some embodiments. In FIG. 3A, data 310 can be monitored and logged by the solid state drive. The data can include attributes or indicators, generated from a monitor program, such as SMART program. For example, the data can include error rates, such as raw read error rate, which is the error rate relative to the number of sectors read in the current power cycle, soft read error rate, which tracts the number of correctable Error Correction Code (ECC) errors, uncorrectable soft read error rate, which is the number of soft read errors that cannot be fixed on-the-fly and requires deep recovery. The data can include error counts, such as reported I/O error detection code errors, which tracks the number of I/O errors encountered during reads from flash memory, reported uncorrectable errors, which tracks the number of uncorrectable error events reported back to the host for all data access commands, ECC on-the-fly error count, which tracks the number of uncorrectable ECC errors. The data can include failure counts, such as program fail count, which counts the number of flash program failures, erase fail count, which counts the number of flash erase failures. The data can include retired block count, a percentage of the retired blocks over the spare blocks at manufacturing time, or a percentage of the remaining spare block over the spare blocks at manufacturing time. The retired block count can tract the number of retired blocks. The data can include reserve (or spare) block count, which is the number of reserve flash memory blocks. The data can include a number of power-on hours, which shows the total or accumulated count of hours in the power-on state. The data can include a number of memory erase, e.g., the erase count or the program/erase cycles, which counts the accumulated number of memories erased across the entire drive over the life of the drive. The data can include wear range delta, which provides a value equal to the difference between the maximum worn flash block and the least worn flash block. The data can include temperature, which reports the temperature inside the solid state drive housing. The data can include SSD life left, which indicates the approximate SSD life left, in term of program/erase cycles (pe cycles) or flash block currently available for use. The SSD life left value can be calculated as a ratio of the remaining pe cycles over the rated pe cycles. The SSD life left attribute can be calculated as a ratio of the remaining spare or reserve block over the spare or reserve blocks at manufacturing time. Typically, the pe cycles can dominate this attribute until the end of life when the defects, e.g., the usage of spare or reserve blocks, starts to play a larger role. The data can include the number of reads from the SSD or writes to the SSD, accumulated over the life of the SSD.

The monitored attributes can be periodically logged 320. The monitored attributes 310 can be logged at regular index intervals to formed index logged attributes 320, such as at a regular number of writes written to the memories of the solid state drive. For example, at a first data logged, the logged attributes can include the accumulated number of writes to the SSD. When the number of writes increases to a new write number, e.g., having a constant write increment (which can be considered as an index interval), the attributes can be logged again.

The monitored attributes can be logged at different times. And the index intervals can be the difference between the accumulated writes at a subsequent logged data and the accumulated writes at a previous logged data.

The monitored attributes 310 can be logged at regular time intervals to formed time logged attributes 320, such as at every hour or at every day. The time of the time logged data can be recorded, together with the logged attributes, thus the time logged data 320 can include the logged time together with the logged attributes. The monitored attributes can be logged at different times, together with the time at the logging process. The time intervals can be the difference between the logged time at a subsequent logged data and the logged time at a previous logged data.

FIG. 3B shows different properties which can be calculated from the index logged data or the time logged data 320. Instantaneous performance 330, e.g., instantaneous properties, of the solid state drive can be calculated from the time or index logged data 320. The instantaneous performance can be calculated using the time or index logged data, such as two or more logged data obtained at different times. For a short interval, the difference between the two logged data can be used to calculate an instantaneous property, e.g., property of the solid state drive in the short interval. The short interval can be long enough so that the difference of the logged data are statistically significant. The short interval can be short enough to be considered instantaneous.

For example, a first/second logged data at a first/second logged time can include the first/second value of erase counts, e.g., the number of erase cycles or pe cycles accumulated from the beginning of the solid state drive until the first/second logged time. The difference between the first and second values of erase counts can be considered as the amount of erase counts consumed during the time interval between the first and second logged times. Thus the life spent of the solid state drive during the time interval is the erase count difference. If the time interval is small, for example, compared to the life time of the solid state drive, then the calculated life spent can be an instantaneous value, showing the usage of the solid state drive at the logged time. A life time expectancy can be calculated using the instantaneous value, for example, by dividing the total number of erase counts to the rate of the erase counts. This life time expectancy can be considered the expected life time of the solid state drive if the solid state drive is under this rate of erase count consumption all the time. In a different calculation, a life time expectancy can be calculated by dividing the remaining erase counts to the rate of the erase counts. This life time expectancy can be considered the remaining life time of the solid state drive if the solid state drive is under this rate of erase count consumption from this moment forward. Both life time expectancies, e.g., expected life time and remaining life time can be considered as the instantaneous life time expectancies, e.g., the lifetime of the solid state drive calculated using the current usage.

The instantaneous performance, e.g., properties of the solid state drive calculated at a point in time, can provide an indication of a surge or drop of performance, such as a change in performance when changing the software accessing the solid state drive, a change in performance when changing a firmware of the solid state drive, or a change in performance when changing the workload of the host that the solid state drive is coupled to. Further, the instantaneous performance can be used in regression test, such as integrated to a regression test, which can provide the performance of the solid state drive under the test conditions for a new load, new software, or new firmware. Thus variation in performance, e.g., the changes in performance for a given software, firmware or load, can be determined, allowing a comparison of different software, firmware and load. This can also offer opportunity to suggest optimization, e.g., knowing which load, which software of firmware having better or worse performance.

The instantaneous properties can provide behaviors of the solid state drive at any instant in time. The instantaneous properties can be the characteristics, e.g., straits, attributes, indicators, parameters, of the solid state drive at any instant in time. In some embodiments, the properties can include data collected in logged data of the logged data set. For example, the properties of erase count is related to the number of flash memory erase, e.g., the program/erase cycles of the flash memory in the solid state drive. A solid state drive can record an accumulated value of erase counts, e.g., the total number of erase counts accumulated from the beginning of the solid state drive.

A series of logged data, e.g., a logged data set, can be used to calculate an instantaneous property, e.g., the property at an instant of time or index. The instantaneous property can be considered as the property of the solid state drive at a particular time, e.g., a snapshot of the property. The logged data, for example, from SMART process for monitoring attributes or indicators of the solid state drive, are typically accumulated data, e.g., the data accumulated from the beginning of the solid state drive. Thus the logged data does not provide information related to changes of behavior, such as changing workload, changing firmware, or changing software, of the solid state drive.

In contrast, the present instantaneous property can provide information at a particular point in time, which can show the changes acting on the solid state drive when compared to an instantaneous property at an earlier time. For example, the solid state drive can experience a first workload. A first instantaneous remaining lifetime calculation under the first workload can provide the remaining lifetime of the solid state drive under the first workload. A second workload then can be applied to the solid state drive. A second instantaneous remaining lifetime calculation under the second workload can provide the remaining lifetime of the solid state drive under the second workload. By comparing the first and second remaining lifetime, the effect of the first and second workloads on the solid state drive can be observed. For example, under the first workload, the remaining lifetime can be calculated to be 10 years. Under the second workload, the remaining lifetime can be calculated to be 10 days. This can show that the second workload can have a severe effect on the solid state drive.

The remaining lifetime calculations can be influenced by the past history of the solid state drive. For example, the remaining lifetime of a new solid state drive can be long, even under a severe workload. In contrast, the remaining lifetime of an almost-used-up solid state drive can be short, even under a light workload.

The lifetime expectation, or the expected lifetime, is not affected by the past history of the solid state drive. The expected lifetime can be simply the time that the solid state drive can last under a workload condition. Thus the expected lifetime can be a better indication of a performance of s solid state drive, e.g., an instantaneous property of the solid state drive.

Since the logged data are collected at different times, e.g., the logged data include discrete values of the parameters or attributes of the solid state drive, proper intervals can be used for representing instantaneous properties. The instantaneous property can be calculated in a time or index interval suitable to be considered instantaneous. For example, the time or index interval can be small or short enough as not to miss changes in the property behavior. The time or index interval can be short enough with respect to the life of the solid state drive. The time or index interval can be large or long enough as to observe changes in the property behavior. The time or index interval can be long enough to be statistically significant.

The time or index interval for calculating an instantaneous property can be short enough so that the characteristics in the interval can exhibit a linear behavior or an approximate linear behavior. The property can be calculated from the characteristics. For example, in piece-wise linear characteristics, if the interval is selected so that the characteristics increase or decrease linearly within the interval, than the interval can be short enough. If the interval is selected so that the characteristics perform a non-linear change, such as increasing and then decreasing, or increasing slowly and then increasing quickly, then the interval is not short enough.

In non linear characteristics, e.g., the characteristics behavior is non linear, if the interval is selected so that the characteristics deviate significantly from a linear approximation, then the interval is not short enough. For example, if the characteristics increase and then decrease in an interval, then the interval is not short enough. If the characteristics increase slowly then increase quickly in an interval, then the interval is not short enough. If the characteristics non-linearly increase slowly in an interval, then the interval can be considered short enough if the non-linearly increase is less than a criterion, such as less than 10%, less than 5% or less than 2%. The criterion can be related to an accuracy of the property calculation.

The time or index interval for calculating an instantaneous property can be long enough so that the characteristics can exhibit some changes, e.g., some properties can be calculated as functions of some characteristic changes. The characteristic changes can be calculated as a rate of change of the characteristics, e.g., the ratio of the change in the characteristics over the interval. If the interval is a time interval, then the rate of change of the change of the characteristics over time. If the interval is an index interval, such as the amount of memory written to the solid state drive, then the rate of change of the change of the characteristics over written memory.

For example, a remaining lifetime of the solid state drive can be calculated from the rate of change of erase counts (also called program/erase cycles). Flash memories can have a maximum number of erase counts, for example, determined by the manufacturing process. Thus, from the rate of change of the erase counts, the remaining lifetime of the solid state drive can be determined, e.g., by projecting to the time needed to reduce the number of erase counts to zero from the erase count usage, e.g., from the rate of change of erase counts.

To calculate the remaining lifetime, an interval can be considered not long enough if the number of erase counts does not change within the interval. For example, the remaining lifetime can be calculated from the erase count using the following formula

maximm number of erase counts=rate of change*remaining lifetime

Thus if the number of erase counts does not change, then the rate of change is zero, and the remaining lifetime cannot be calculated.

In some embodiments, the interval can be considered long enough if there is a change in the characteristics of the logged data set that can be used in the calculation of the properties. For example, the calculation of remaining lifetime uses the characteristic of number of erase count, thus the interval between the logged data used in the calculation of remaining lifetime will need show changes in the erase counts, to be considered long enough. Other properties can require changes in different characteristics. For example, calculation of read or write error behavior will use the characteristics of read and write error rates, and thus a long enough interval would require that the read and write error rates exhibit some changes.

In some embodiments, the interval can be considered long enough if the change in the characteristics of the logged data set that can be used in the calculation of the properties can meet an error criterion, e.g., an uncertainty criterion, in the calculation of the properties. For example, a previous value can be L₁=10 unit, it would have an uncertainty of 0.5, since any value between 9.5 and 10.5 would be round to 10. If the previous value is changed to a currently value of L₂=11 unit, it would also have an uncertainty of 0.5. The unit can be the number of digits used to store the value

An error or uncertainty associated with the change, e.g. from the previous value to the current value can be calculated from the uncertainty of these values. For example, the rule of adding in quadrature can be used to calculate the error in the difference. Thus the error associated with the value change can be calculated as

E=\sqrt{0.5²+0.5²}=0.5\sqrt{2}=0.7

A relative error associated with the change can be E/(L₂−L₁), which is 70%. Thus any property calculated from this change would have at least an uncertainty of 70%. To reduce the error, higher value of change would be used.

In some embodiments, the interval can be considered long enough is the characteristic changes can meet an error or uncertainty criterion. For example, in the above example, if an error of 7% is used, then the change in value would be at least 10.

The length of the time or index interval can be determined with respect to the life of the solid state drive, which can be determined by the operating time, e.g., lifetime, of the solid state drive, by the maximum number of erase count or the maximum number of writes performed on the solid state drive.

Thus an index or time interval can be considered short enough when the interval is less than about 0.5, 1 or 2 percents of the lifetime, the maximum erase count or the maximum number of writes. For example, if a solid state drive has a maximum erase count of 10,000, then an interval is short enough when it includes less than about 50, 100 or 200 erase counts.

An index or time interval can be considered long enough when the interval is greater than about 0.1, 0.2, 0.5 or 1 percent of the lifetime, the maximum erase count or the maximum number of writes. For example, if a solid state drive has a maximum erase count of 10,000, then an interval is long enough when it includes more than about 10, 20, 50 or 100 erase counts.

In some embodiments, specific lengths for the interval can be used. For example, the interval can be less than about 0.5, 1 or 2 percents of the lifetime, the maximum erase count or the maximum number of writes. The interval can be greater than about 0.1, 0.2, 0.5 or 1 percent of the lifetime, the maximum erase count or the maximum number of writes.

In some embodiments, an iteration process can be used to determine whether or not the interval is short or long enough, or to determine an optimum short or long enough interval. For example, an initial interval can be selected, and the characteristic behavior in the selected interval is evaluated. If the change of the characteristics in the interval meets the criterion, e.g., exhibiting a linear or an approximate linear behavior, then the interval is considered short enough. The interval then can be shortened or lengthened, depending on the previous result, and the new interval is re-considered. When two successive intervals show a change, e.g., from short enough to not short enough, then the short enough interval can be considered an optimum short enough interval.

To consider if an interval is long enough, an initial interval can be selected, and the characteristic behavior in the selected interval is evaluated. If the change of the characteristics in the interval meets the criterion, e.g., exhibiting a change in a characteristic, or the characteristic change can provide acceptable error in the calculation of the property, then the interval is considered long enough. The interval then can be shortened or lengthened, depending on the previous result, and the new interval is re-considered. When two successive intervals show a change, e.g., from long enough to not long enough, then the long enough interval can be considered an optimum long enough interval.

In some embodiments, the present invention discloses methods and system for calculating an instantaneous property of a solid state drive. An instantaneous property can be considered as the property of the solid state drive at an instant in time. The instantaneous property can be calculated from a time or index curve, e.g., using a curve fitting on multiple discrete values of the property or characteristics. For example, from the fitted curve, a value for the property at a particular time or index can be obtained substituting the time or index to the fitted curve. Other operations can be used, such as derivative or integral. For example, a curve fitting can be used for the numbers of erase counts as a function of time. The instantaneous value of consumed erase counts can be obtained by taking derivative of the fitted curve.

In some embodiments, the instantaneous property can be calculated by the logged data in multiple intervals. A curve fitting can be used to form a fitted curve, showing the behavior of the characteristics as a function of time or index. For example, the consumptions of erase counts in multiple intervals can be curve fitted to generate a curve of the usage of erase counts at different times or indexes. The remaining lifetime can be determined by calculating from the curve of the consumed erase counts or remained erase counts, showing when the consumed erase counts reach the maximum number of erase counts or when the remained erase counts reach zero. For example, an integration of the erase count usage curve can be used to determine the time or index when the erase count consumption reaches the remaining number of available erase counts.

An instantaneous erase count property can be the number of erase counts consumed at an instant in time. The instantaneous erase count consumption property can be calculated as a derivative of a fitted curve of the accumulated erase counts v. time or index.

The properties of lifetime is related to the remaining time of solid state drive (e.g., the time that the solid state drive can still be in operation) or the remaining index of solid state drive (e.g., the index can be the number of memories written to the solid state drive, and thus the remaining index can be the amount of memories that can still be written to the solid state drive). A solid state drive can calculate and record an operation-average lifetime, e.g., a remaining lifetime typically expressed in an index (such as number of memory written to the solid state drive). The operation-average lifetime can be calculated as an average value for the duration of the solid state drive operation. For example, the operation-average lifetime can be calculated from an accumulated erase counts and an accumulated memory written to the solid state drive.

An instantaneous lifetime property can be the remaining time of index at an instant in time, e.g., the remaining time or index calculated using the instant behavior, optionally with the past behavior of the solid state drive. The instantaneous lifetime property can be calculated using the instantaneous erase count, such as using the instantaneous erase count to project the remaining time for the complete consumption of all the erase counts. For example, an instantaneous erase count can be determined for an instantaneous interval, and the remaining lifetime can be determined as a ratio of the remaining erase counts over the instantaneous erase count. The remaining lifetime can be calculated as an integral of a function of instantaneous erase count v. time or index.

The instantaneous properties of the solid state drive can provide better accuracy, together with identifying changes in behavior and performance of the solid state drive, e.g., due to changes in load conditions, or firmware or software changes.

In some embodiments, the instantaneous properties can be calculated using adjusted data in the logged data set. Logged data in the logged data set can be collected at different times, thus can be at different conditions, such as at different operating temperature. The data in logged data set can be adjusted, for example, to be at a same temperature, before being used for calculating the instantaneous properties. The adjustment can use relationships between attributes in the logged data set, as discussed below.

Time evolution performance 340 of the solid state drive can be calculated from the time or index logged data 320. The time evolution performance can be a collection of instantaneous performance, e.g., forming a graph of performance as a function of time. The time evolution performance can include the performance calculated from time evolution attributes, e.g., from graphs of instantaneous attributes as a function of time. The time evolution performance can provide a better accuracy in calculating the performance, since the calculation is based on complete graph of attributes as a function of time.

The time evolution performance can be calculated from values of the attributes collected in the logged data set, e.g., properties of a solid state drive can be calculated based on the graph of the logged data set as a function of time or index. The properties can be calculated based on an extrapolation of a curve fitting from the time or index evolution graphs. The extrapolation can be based on a portion of graphs, such as a current graph portion if there are big changes such as changing workloads, changing firmware or software. Thus the property calculation from the graphs can provide an estimate of the behavior of the solid state drive based on the current operation conditions. The calculation from a graph or a portion of a graph can provide better accuracy, for example, comparing to a calculation using 2 points.

For example, the number of erase counts, e.g., the accumulated number of erase counts, can be collected in the logged data at different collected times. The accumulated erase counts can be plotted against the collected time, forming a graph of erase counts v. time. The time evolution remaining lifetime of the solid state drive can be calculated from the graph, such as by projecting the graph of erase counts to the maximum number of erase counts. For example, a curve fitting can be used, generating a function of erase counts v. time. From the function, the remaining lifetime can be calculated, which is the time that the erase counts reaches the maximum number of erase counts.

The time evolution performance can be calculated from time average values of the instantaneous attributes. For example, the rates of erase counts can change as a function of time, forming a graph of erase count rates v. time. The time evolution remaining lifetime of the solid state drive can be calculated from the average rate of erase counts, e.g., by diving the number of remaining erase counts to the average rate of erase counts.

The time evolution performance can be calculated from integrated values of the instantaneous attributes. The instantaneous values of attributes can be plotted as a function of time or index. A curve fitting can be obtained from the plot. The curve fitting can be used to calculate a property of the solid state drive. For example, instantaneous values of the rates of erase counts, e.g., the number of erase counts in a time or index interval short enough to be considered instantaneous, and long enough to be statistically significant, can be curve fitted in a period of logged data collection. The fitted curve of erase count rates can be used to calculate the remaining lifetime, by integrating or extrapolating the fitted curve to a maximum number of erase counts.

Cross variable effect 350 of the solid state drive can be calculated from the time or index logged data 320. For example, the effect of temperature on performance can be derived from the time or index logged data 320. Since the attributes can include temperature, the other attributes of the logged data collected at a same time can be viewed as dependent on the temperature at the collected time. Using logged data for different time, a dependency of other attributes to temperature can be determined. For example, same temperature at different logged time can be used to calculate variation of the other attributes for a same temperature. Different temperature at different logged time can be used to calculate relationship of the other attributes with respect to temperature.

In some embodiments, the logged data can be collected from attributes of a monitor program, such as SMART program. This can allow a quick performance calculation of the drive behavior, together with using real data.

In some embodiments, the graphs, and the calculation based on the graphs, can used adjusted attributes, e.g., the attributes at different logged data can be adjusted to be conformed to a same characteristic, such as at a same temperature. For example, multiple logged data can be obtained at different times, and thus the temperature of some of the multiple logged data can be different. An adjustment of the characteristic values can correct the condition difference, allowing the property calculations to be calculated at same conditions by using the adjusted characteristic values. A temperature can be chosen, and the attributes, such as the erase counts, at the logged data that have a temperature different from the chosen temperature can be adjusted to be at a same temperature as the chosen temperature (e.g., adjusted to be at the chosen temperature). The temperature can be an attribute of the logged data, so the temperatures of the multiple logged data can be obtained from the logged data.

In some embodiments, relationships between the attributes of the logged data can be obtained from the series of logged data. For example, write error rate (which is a first attribute of the logged data) can be plotted as a function of temperature (which is a second attribute of the logged data). From the plot, a relationship of write error rate and temperature can be obtained. Since there can be multiple logged data with a same temperature, the plot can have multiple values at a same temperature. For example, in a first logged data, a first write error rate can be obtained for a first temperature, resulting in a first write error rate v. first temperature in the plot. In a second logged data, a second write error rate can be obtained for a same first temperature, resulting in a second write error rate v. first temperature in the plot. Thus there can be two values of write error rate for a same first temperature. A curve fitting can be used for calculating a relationship between the attributes, such as a relationship of write error rate v. temperature. This relationship can be used to adjust the values of write error rate, so that calculations on the write error rate can be performed at a same temperature. Other attributes, such as erase counts, can be adjusted using curve fitting, for another attribute in the logged data.

In some embodiments, the adjustment can be performed using relationships between the characteristics. For example, a curve fitting of erase counts as a function of temperature, with values of erase counts and temperature collected from logged data set, can form a relationship between the erase counts and temperature. The relationships can allow changing the values of the characteristics to be at same conditions for the calculations of properties.

In some embodiments, best case, worse case, and average case scenario can be calculated for the properties of the solid state drive. In the best case scenario, the attributes are adjusted to a best performance, based on the second attribute. For example, the erase counts can be adjusted to a lowest temperature of operation of the solid state drive. The remaining lifetime of the solid state drive calculated based on the lowest temperature adjusted erase counts can be the longest lifetime, since lower temperature can provide a better performance. Similarly, the remaining lifetime of the solid state drive can be calculated based on the highest temperature or average temperature adjusted erase counts, resulting in lowest or average lifetime, respectively.

In some embodiments, the present invention discloses a time or index logging process, which can include logging attributes of a solid state drive at different times (for index logging process), together with optional timestamp at the logged times (for time logging process). A program, such as a monitor program, can run in a solid state drive for collecting attributes related to the operation and reliability of the solid state drive. The attributes can be periodically logged, e.g., forming attribute series collected at different times to be stored in a memory, for used in calculation of the performance of the solid state drive.

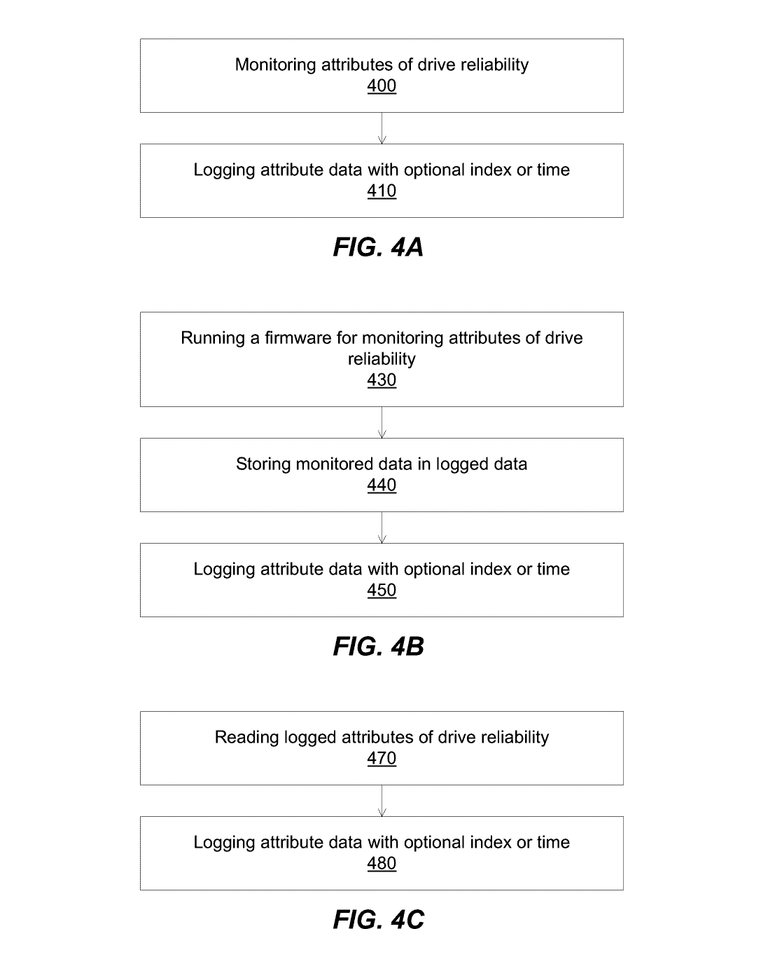

FIGS. 4A-4C illustrate flow charts for forming time or index logged data according to some embodiments. In FIG. 4A, attributes of a solid state drive can be periodically recorded. The attributes can be generated by a program for monitoring the solid state drive. The time of the recording of the attributes can also be recorded. Thus the recording process can generate a time evolution of the attributes of the solid state drive.

Operation 400 monitors attributes of a drive reliability. Operation 410 logs the attributes with optional timestamp. The attributes can be logged at different time or index intervals. The index can be an attribute, such as a number of memory written or a number of memory erased (pe cycles). For example, the attributes can be logged at constant time or index intervals, such as logged at every hour, every day, every terabyte written, or every gigabyte erased. The attributes can be logged at different time or index intervals, such as logging when the host or the solid state drive is not busy. The time/index logged attributes can be used to calculate properties of the solid state drives, including time related properties, instantaneous properties, time evolution properties, and relationships between various attributes or relationships between the properties and attributes.

In FIG. 4B, operation 430 runs a firmware for monitoring attributes of a drive reliability. The firmware can be stored in the solid state drive. Operation 440 stores the monitored attributes, either in the solid state drive or in a host coupled to the solid state drive. Operation 450 periodically logs the stored attributes with optional timestamp.

In FIG. 4C, operation 470 reads logged attributes of a drive reliability. Operation 480 periodically logs the stored attributes with optional timestamp.

In some embodiments, the present invention discloses using an existing monitor program, such as the SMART program, for monitoring and logging the attributes of a solid state drive. The solid state drives can have a monitor program, either the SMART program or a similar monitor program, for monitoring the indicators of the solid state drives for detecting and reporting the drive reliability, for example, for anticipation of hardware failures. The existing monitor program, such as the SMART program, can store the accumulated attributes, meaning the values of the attributes generated from the beginning of the solid state drives. For example, the erase count value, or the memory write value, can be the accumulated values, which are the sum of the added erase counts or the sum of the memory writes. The existing monitor program can store the current value, such as the temperature of the inside of the solid state drive.

In some embodiments, the existing monitored attributes can be periodically logged, thus can provide a time evolution attributes of the drives, together with a simplicity way of collecting attribute data. The logged data can include a series of groups of attributes, e.g., a first group of attributes logged at a first time, a second group of attributes logged at a second time, etc. Each group of attributes can include the accumulated attributes generated by the monitor program, such as the SMART program. An attribute in the group of attributes can be used as an index for the series of attribute groups. For example, the attribute of memory writes (the number of gigabytes of data written to the solid state drive), or the attribute of memory erases (the number of program/erase cycles performed on the memories of the solid state drive) can be used as an index for plotting time evolution graphs of the other attributes. For example, the number of memory erases can be formed as a function of memory writes (e.g., memory writes acting as an index for the evolution of memory erases). The logged data can be stored in the solid state drive or in the host system.

The logged data can also include the time of logging. For example, a first group of attributes can be logged, together with the time of the logging of the first group. The second group of attributes can be logged with the time of the logging of the second group. The logged time can be used as an index of plotting the time evolution graphs of the attributes. For example, the number of memory erases can be formed as a function of time.

In some embodiments, an integrated monitor program can be used, which can combine the functionality of existing monitor programs, together with the ability to store the attributes, and optionally a time stamp, at different times.

In some embodiments, a history of SMART attributes, e.g., the outputs generated by a SMART monitoring program, can be stored as a function of index or time. In other words, the SMART attributes are stored at more than 1 point in index or time. The data storing can be performed by an index or time logging process. The data can be logged and saved to the solid state drive or to a host system connected to the solid state drive. Afterwards, the stored data can be analyzed and displayed, for example, by an analyzer program which can be stored in the solid state drive or in the host system. The analyzer program can use the stored SMART history to calculate and display behavior and/or performance of the solid state drive, such as life expectancy and effects of workload, firmware or software on the performance or life expectancy of the solid state drive.

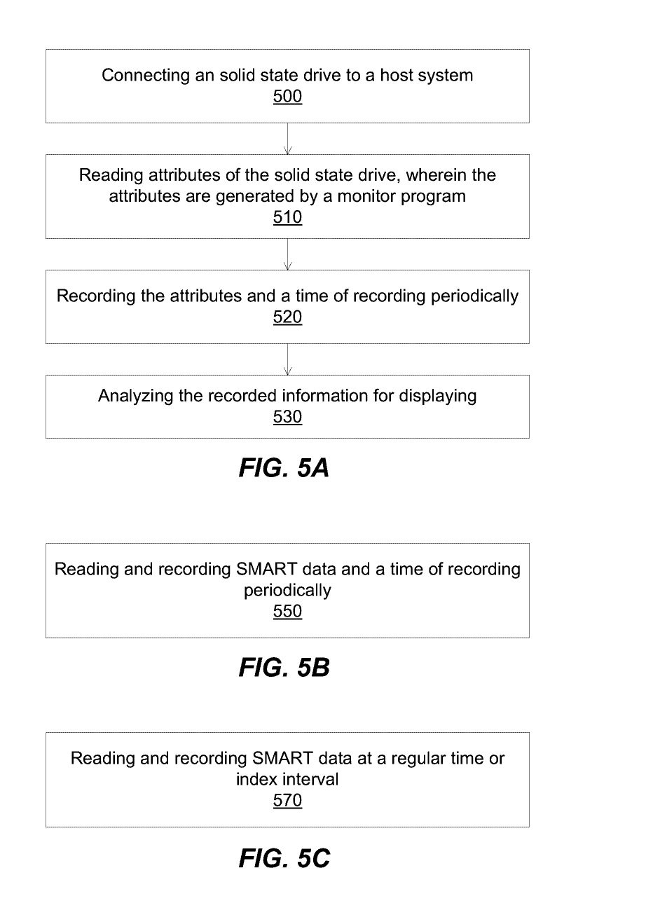

FIGS. 5A-5C illustrates flow charts for generating an index or time logging process according to some embodiments. In FIG. 5A, operation 500 connects an solid state drive to a host system. The host system can have a software running, e.g., a program executed by the host that can access the solid state drive. The solid state drive can experience a workload of the host system, e.g., the host system can write data to the solid state drive or the host system can read data from the solid state drive. The solid state drive can have a firmware running, e.g., a program executed by the solid state drive, which can include operations that are essential to the operation of the solid state drive, such as wear leveling, flash layer translation, and attribute monitoring.

Operation 510 reads attributes of the solid state drive, wherein the attributes are generated by a monitor program. The monitoring program can include a SMART program, which generates attributes or indicators related to the reliability of the solid state drive. The monitoring program can include a firmware, executed by the solid state drive.

Operation 520 records the attributes and optionally a time of recording periodically. The attributes can include a total number of bytes written to or read from the solid state drive. The attributes can include a total number of erase cycles performed on the flash memories of the solid state drive. Other attributes can be recorded, such as a wear leveling efficiency, e.g., the delta of wear leveling, or the maximum and minimum numbers of erases cycles on the flash memories. The attributes can be stored in the solid state drive, such as in a log file in the solid state drive. The attributes can be stored in the host system, such as in a log file in the host system.

Operation 530 analyzes and displays the recorded information. Since the recorded information can be time-related information, e.g., the recorded information are recorded in different times, time related characteristics can be determined, such as a life expectancy of the solid state drive in term of time such as dates or years. In addition, snapshot characteristics of the solid state drive can be determined, allowing the distinction of different characteristics at different times, for example, due to changes in workload, software or firmware. Further, the characteristics with better accuracy can be determined, for example, through the time evolution of the collected attributes.

In some embodiments, a solid state drive can provide life acceleration parameters in SMART data, such as the number of erase cycles and/or the level of wear leveling among the flash memories. The life acceleration parameters can be periodically read, for example, by a host system. The periodicity of the reads can be determined by the host. For example, the host can decide to read the life acceleration parameters at a time period such as every hour or every day, or at a memory write period, such as every gigabyte or every ten gigabyte written to the solid state drive. The host can read the life acceleration parameters at different times, such as when the solid state drive is connected, or when an external condition is met.

In FIG. 5B, operation 550 reads and records SMART data and optionally a time of recording periodically. A solid state drive can be connected to a host system. The host system can read the SMART attributes stored in the solid state drive. The host system can optionally read the time of the SMART attribute reading. The SMART attributes and the optional time stamp can be stored, either in the solid state drive or in the host system. The SMART attribute reading and the time reading can be repeated, to generate a history of SMART attributes, or to generate a time evolution of SMART attributes as a function of time (or as a function of other attributes, such as memory written).

In FIG. 5C, operation 570 reads and records SMART data at a regular time or index interval. A solid state drive can be connected to a host system. The host system can read the SMART attributes stored in the solid state drive at a regular time or index interval. For example, the host system can read the SMART attributes at a time interval such as 1 hour, 10 hours, 1 day, or 10 days. The host system can read the SMART attributes at an index interval such as 1 gigabyte written, 10 gigabyte written, or 1% of erase cycles.

A combination of SSD and host system can be used when logging the data, e.g., reading and storing the SMART attributes. The combination of SSD and host can reduce the workload on the SSD, allowing the SSD to have improved performance. Alternatively, the method can use the SSD for logging.

The SSD can provide life acceleration parameters, e.g., attributes or indicators, in SMART data. For example, the SSD can have firmware that records attributes or indicators of the SSD characteristics, such as Raw Read Error Rate, Retired Block Count, Power-On Hours, Device Power Cycle Count, Soft Read Error Rate, Gigabytes Erased, Reserve Block Count, Program Fail Count, Erase Fail Count, Unexpected Power Loss, Wear Range Delta, Program Fail Count, Erase Fail Count, Reported I/O Error Detection Code Errors (IOEDC errors), Reported Uncorrectable Errors (URAISE), Temperature, ECC On-the-Fly Error Count, Reallocation Event Count, Uncorrectable Sector Count, SATA R-Errors Error Count, Uncorrectable Soft Read Error Rate (UECC), Soft ECC Correction Rate (UECC), Drive Life Protection Status, SSD Life Left, Available Reserved Space, Power Fail Backup Health, Lifetime Writes from Host System, Lifetime Reads to Host System. The essential parameters can include data writes, data reads, NAND consumption parameters (NAND erase count), and life remaining percentage. Other parameters can provide an indication of performance, such as the temperature of the SSD.

The SSD can be used in a host system. For example, the host system can read and record the life acceleration parameters from SSD. The host system can decide the period of the read. Each entry can be called a record. In some embodiments, the SSD can read and record the parameters. Each record can be time stamped and/or indexed. The index can be data index, e.g., an index based on the sizes of memory written. For example, each index can represent 1 GB or 100 MB of data that is written to the SSD.

When there are 2 or more records, life acceleration can be calculated, such as a remaining life expectancy of the SSD. The calculation can use the life acceleration parameters of SSD, and time stamps and/or indexes from the host. The two records can provide the characteristics and behaviors of the SSD in the time intervals specified by the time stamps. From the time interval data, other characteristics of the SSD can be calculated, such as the time expectancy can be projected from the usage of the SSD in the calculated time interval. The calculation from the SMART attributes can provide a user an estimate of remaining memory amount that can be written, and a remaining operation time of the SSD based on the real usage.

In some embodiments, the present invention discloses methods to generate time evolution of characteristics of a solid state drive. The methods can include periodically recording the characteristics of the solid state drive, together with the time of recording.

In some embodiments, the solid state drive can be connected to a host system, and the host system can perform the recording process. The characteristics can be generated by a firmware in the solid state drive, thus the host can simply read the characteristics from the solid state drive, and then perform the recording. The firmware can include a monitor program such as a Self-Monitoring, Analysis and Reporting Technology (SMART) system. The characteristics, called attributes in SMART system, can include an accumulated value of wear leveling of the memory of the solid state drive, a number or percentage of memory erased or a difference between most worn and least worn memories, a percentage of remaining erase cycles or a percentage of erase cycles performed, an inside temperature of the solid state drive, an accumulated error rate of the solid state drive, a number of remaining reserved block count or a number of retired block count, an accumulated number of memory read or memory written, an accumulated number of power on hours, or a value of remaining life in term of percentage of erase cycles or in term of reserved memory block.

The recordation process can be performed at a regular time interval, e.g., after every other days, or twice a week. The recordation process can be performed at a regular index interval. The index interval can include the time for some actions to happen. For example, the index interval can include the time in which there is a regular amount of memory is written to the solid state drive, e.g., after 1 Gbytes is written to the solid state drive.

The characteristics can be recorded in a memory portion of the solid state drive, or can be recorded in the host. After the recording, the recorded information can be analyzed, for example, to obtain information related to the behavior of the solid state drive, such as the remaining lifetime of the solid state drive.

In some embodiments, the present invention discloses using a series of logged data, e.g., a logged data set, to determine and display properties or behavior of a solid state drive. The series of logged data can include the time when the data is logged, thus can form a time series of logged data, e.g., a time evolution of the logged data, such as the changes of the attributes or indicators of the solid state drive as functions of time. The time evolution of the logged data can allow the determination of instantaneous properties or behavior of the solid state drive, or can allow the determination of properties or behavior of the solid state drive with better accuracy, since the calculations can be based on an extrapolation from a curve. In addition, the time evolution of the logged data can allow the expression of the properties or behavior of the solid state drive in term of time, such as the solid state drive can have a remaining lifetime of 10 days, 10 weeks, 10 months, or 10 years under the current workload, firmware and/or software.

The series of logged data can have only the data logged at different times, e.g., without including the time when the data is logged, thus can form an index series of logged data, e.g., an index evolution of the logged data. The index can be an attribute or indicator in the logged data, such as a number of writes performed on the solid state drive. For example, the index series of logged data can include changes of the attributes or indicators of the solid state drive as functions of an attribute or indicator. The index evolution of the logged data can allow the determination of instantaneous properties or behavior of the solid state drive, or can allow the determination of properties or behavior of the solid state drive with better accuracy, since the calculations can be based on an extrapolation from a curve.

In some embodiments, attributes from two or more logged data can be used to calculate properties of the solid state drive. For example, life acceleration parameters of the solid state drive, such as erase counts, and the time or index interval from the two or more logged data can be used to calculate the remaining memory amount that can be written to the solid state drive, and/or the remaining operation time of the solid state drive. The calculations can be based on the number of manufacturing determined maximum erase counts, and the consumption of erase counts in the time of index interval. Since the life acceleration parameters, e.g., the indicators collected from the solid state drive, are based on real usage of the solid state drive, the calculation of remaining lifetime can also be based on real time operation, and not from modeling of the solid state drive behavior.

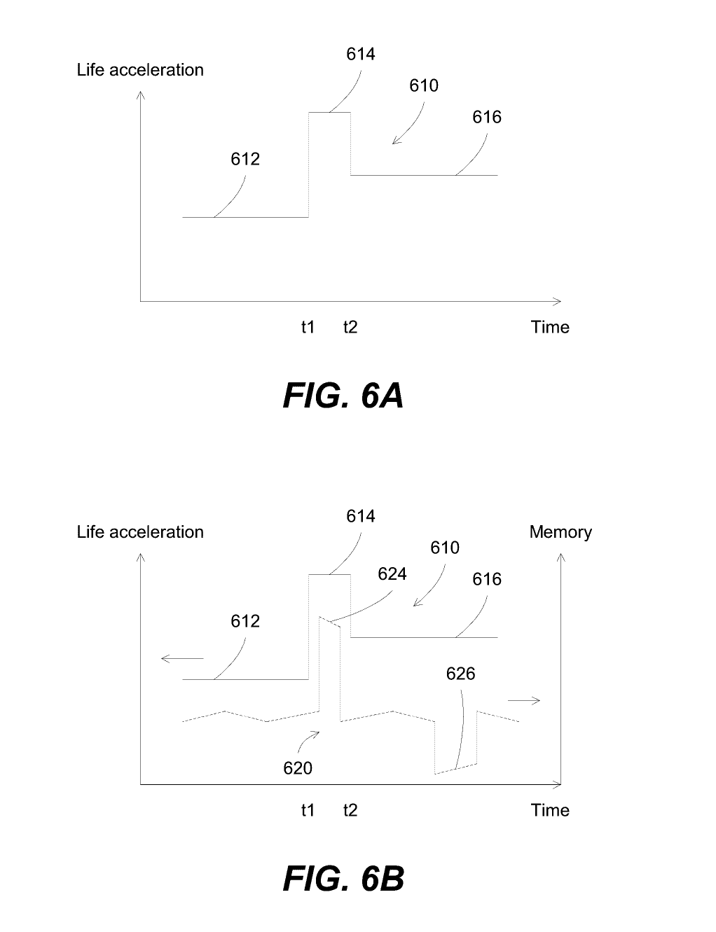

FIGS. 6A-6B illustrate a visualization of life acceleration according to some embodiments. Life acceleration data of a solid state drive can be shown as a function of time, e.g., the values and the changes of life acceleration data can be displayed. The life acceleration data can include properties that affect, e.g., decrease, the lifetime of the solid state drive, such as the number of erase counts, the rates of erase counts, the write amplification factor, the error rates, the number of spare blocks, the rates of spare block consumption, and the lifetime expectancy of the solid state drive. Different time periods can be used for showing the life acceleration data, such as a portion of the operation time or a whole operation time of the solid state drive.

The flash memories of a solid state drive can have a maximum number of erase counts, sometimes called NAND erase count, NAND erase count parameter, or NAND consumption parameter. This value can be kept tracked of, either as a number of erase counts already performed, or a number of erase counts remaining from the maximum number of erase counts, such as by a SMART monitoring process in the solid state drive. A remaining lifetime of the solid state drive can be determined by extrapolating the number of erase counts already performed to the maximum erase counts, or by extrapolating the number of remaining erase counts to zero.

The flash memories of a solid state drive can have a maximum number of spare blocks of memories, sometimes called reserve block count, or spare block count. This value can be kept tracked of, such as by a SMART monitoring process in the solid state drive. A remaining lifetime of the solid state drive can be determined by extrapolating the erase counts to the maximum erase counts.

A combination of erase counts and spare blocks can be used to calculate the remaining lifetime of a solid state drive. For example, in the early stage of the solid state drive, the life of the solid state drive can be determined by the erase counts. For example, during the first 90% of the maximum erase counts, the life of the solid state drive can be determined by the consumption rate of the erase counts. In the late stage of the solid state drive, the life of the solid state drive can be determined by the spare blocks. For example, during the last 10% of the maximum erase counts, the life of the solid state drive can be determined by the consumption rate of the spare blocks. Other methodologies can be used to calculate the remaining lifetime.

In some embodiments, the logged data can contain a remaining lifetime attribute, for example, a SMART monitor process can determine and store an attribute of remaining lifetime. The remaining lifetime attribute can be calculated by the consumption of erase counts, spare blocks, a combination of erase counts and spare blocks, or by any other methodologies.

FIG. 6A shows a graph 610 of a life acceleration property as a function of time. The graph can show a surge in life acceleration value at time t1, e.g., from value 612 to value 614. The graph can show an increase in life acceleration value at time t2, e.g., from value 612 to value 616.

The graph can allow a user to observe a change in life acceleration properties, including knowing when the changes occur, which can assist in finding a cause for the changes. For example, a surge of life acceleration property can be seen from time t1 to time t2. Knowing the time period, the cause for the anomaly can be found. An increase in life acceleration property can be seen, e.g., before time t1 as compared to after time t2. A comparison of life time acceleration properties around the time period of t1−t2 can help in identify issues and problems that affect the performance of the solid state drive.

FIG. 6B shows a graph 610 of a life acceleration property together with a graph 620 of an amount of data written to a solid state drive as a function of time. In addition to the life acceleration property, the amount of written data to the solid state drive can also be displayed. The amount of data written can complement the life acceleration property, for example, by provide additional assessments to the life acceleration property. For example, for a low number of written data 626, there can be high error to the life acceleration data, due to the low number of raw collected data. Similarly, an abnormally high number of written data 624 can be show that the data can be not representative, e.g., an one-time occurrence. In general, a constant number of written data can show a higher reliability for the life acceleration data.

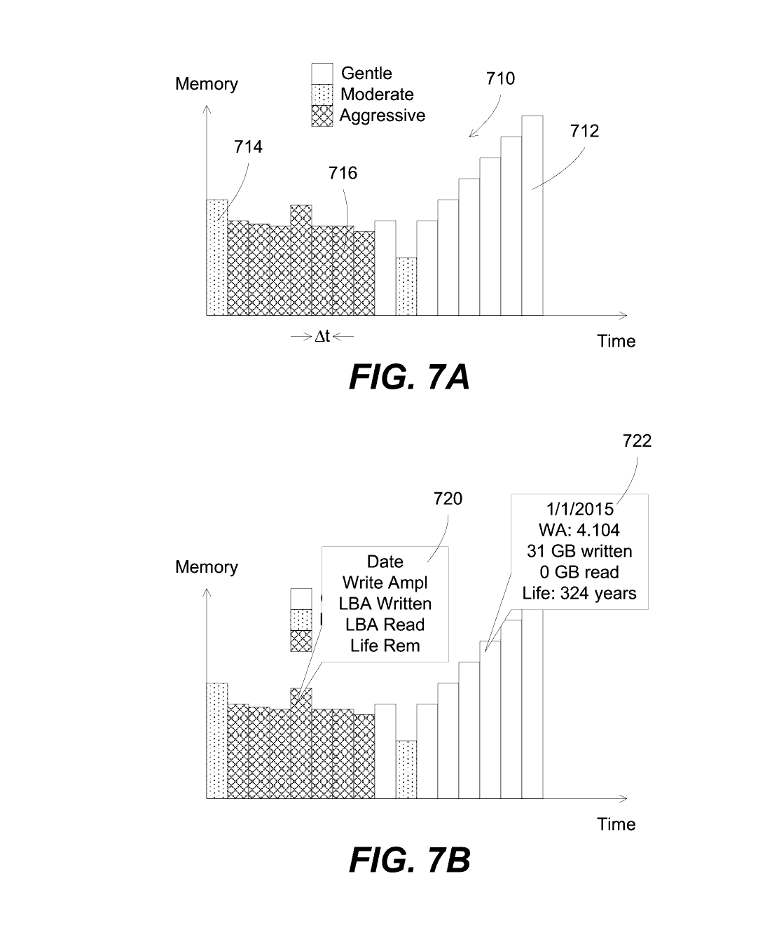

FIGS. 7A-7B illustrate a visualization of life acceleration according to some embodiments. Values of written data to the solid state drive can be displayed as a function of time. The written data points can also be labeled with a life acceleration property or characteristic of the solid state drive, such as good performance, average performance, or poor performance. The life acceleration data, together with the values of written data, can provide a good indication of the time evolution of the performance of the solid state drive.

FIG. 7A shows a graph 710 of values of written data, such as a number of GBytes written to the solid state drive, as a function of time, together with a life acceleration characteristic for each data point. As shown, the graph includes amount of written data for a time interval Δt, forming discrete data bars, such as data bars 712, 714, or 716. Other configurations can be used, such as a continuous graph for instantaneous times, instead of discrete time intervals Δt. The written data can also include a life acceleration characteristic, such as an effect of the written data on the solid state drive, including gentle writing, moderate writing, or aggressive writing on the flash memories of the solid state drive. For example, the life acceleration characteristic can include a write amplification factor. A gentle writing characteristic can mean a range of write amplification factor between 1 and 2. As shown, written data 712 can have a gentle writing characteristic. A moderate writing characteristic can mean a range of write amplification factor between 2 and 4. Written data 714 can have a moderate writing characteristic. And an aggressive writing characteristic can mean a range of write amplification factor greater than 4. Written data 716 can have an aggressive writing characteristic. Other ranges can be used. The number of range divisions can be used, such as 5 divisions instead of 3.

Other life acceleration characteristics can be used, such as erase counts, erase count rates, remaining lifetime, or expected lifetime. For example, the life acceleration characteristic can include an expected lifetime, such as a percentage of a standard lifetime of the solid state drive. A gentle writing characteristic can mean a higher lifetime than the standard lifetime, such as greater than 150% of the standard lifetime. A moderate writing characteristic can mean a similar lifetime as the standard lifetime, such as between 50 and 150% of the standard lifetime. An aggressive writing characteristic can mean a lower than the standard lifetime, such as lower than 50% of the standard lifetime. Other ranges can be used.

FIG. 7B shows a graph of values of written data, together with more detail information on life acceleration characteristic for each data point. Values for written data can be shown as a function of time, together with ranges of life acceleration characteristic, e.g., gentle, moderate and aggressive.

Pop-up screens 720 and 722 can be shown. For example, when a pointer, such as a mouse pointer, is pointed at a written data point, detail information of the time period of the written data can be shown, such as the date or the time period of the written data, the write amplification factor value, the number of memory written, the number of memory read, and the remaining lifetime. Other information can be included, such as a life expectancy, error rates, and erase count rate. The pop-up screens can show data in addition to the life acceleration characteristic built in the memory bars, such as the remaining lifetime or the expected lifetime. The pop-up screens can show the life acceleration characteristic with more precision as compared to the life acceleration characteristic built in the memory bars. For example, the pop-up screens can show the date of the range of time (as compared to the time read from the time axis), the amount of written data (as compared to the memory values read from the memory axis), the write amplification factor, the remaining lifetime, and the expected lifetime (as compared to the range of gentle/moderate/aggressive for life acceleration characteristic).

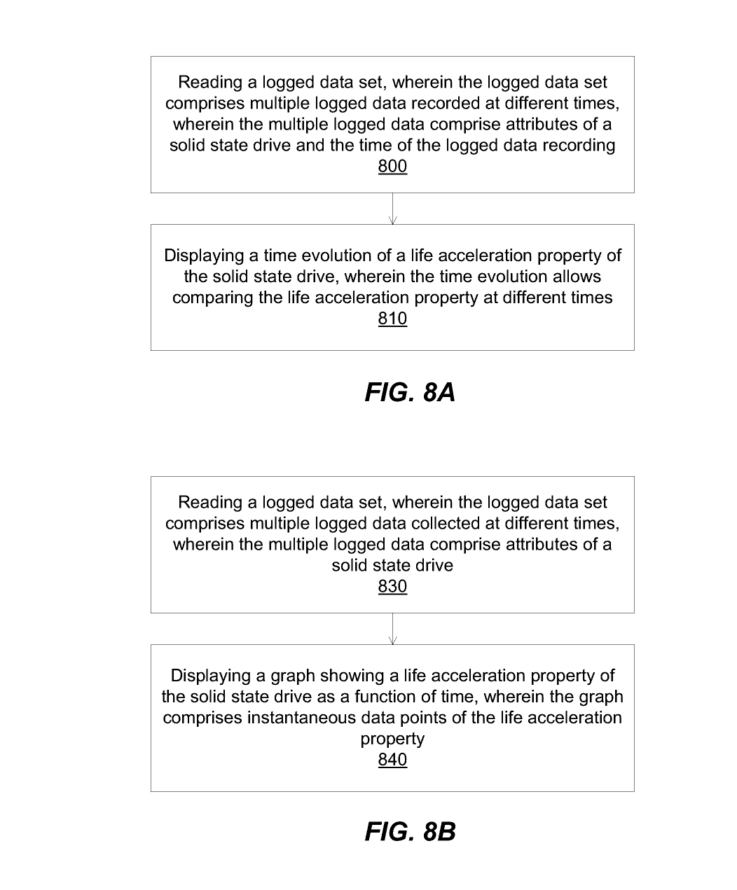

FIGS. 8A-8B illustrate flow charts for displaying life acceleration properties according to some embodiments. FIG. 8A shows a flow chart for display a life acceleration property, such as erase count rates or remaining lifetime as a function of time. Operation 800 reads a logged data set, wherein the logged data set comprises multiple logged data recorded at different times, wherein the multiple logged data comprise attributes of a solid state drive and the time of the logged data recording. Operation 810 displays a time evolution graph of a life acceleration property of the solid state drive. The time evolution graph can include life acceleration data as a function of time, thus can allow comparing the life acceleration property at different times.

In some embodiments, the life acceleration property can include a remaining lifetime of the solid state drive in unit of time, or a remaining amount of memory that can be written to the solid state drive. The remaining lifetime can inform the user about the time to replace the solid state drive. The life acceleration property can include a lifetime of the solid state drive calculated based on an usage of the solid state drive in a data point of the time evolution curve. The lifetime of the solid state drive can be an expected lifetime, or a lifetime expectancy of the solid state drive, meaning how long a new solid state drive would last based on a particular point in the time evolution graph. For example, a user can select a time period, and can trace from the time evolution curve the expected lifetime of the solid state drive for the operating conditions in that time period.

A difference between the remaining lifetime and the lifetime, e.g., the expected lifetime, is that the remaining lifetime is calculated while taken into account the past history of the solid state drive while the expected lifetime is not concern with the past history. In other words, for a new solid state drive, the remaining lifetime and the expected lifetime can be similar or the same.

The life acceleration property can include an instantaneous property, or a life acceleration property representative of an instant or of an period of time. For example, an expected lifetime at a point in time or in a time period can be an instantaneous property, since it can be calculated using only data at that time or in that time period.

In some embodiments, the method can include calculating the life acceleration property using the logged data set. For example, the logged data set can include multiple values of different attributes, with the multiple values collected at different times. The attribute values can be used to calculate the life acceleration property, such as by a curve fitting process or by calculations using discrete values. For example, the values of accumulated erase counts can be curve fitted to a function of number of erase counts and time. A remaining lifetime can be extracted from the fitted curve by determining the time that the number of erase counts reaches the maximum number of erase counts of the solid state drive. An erase count rate can be extracted from the fitted curve by taking derivative of the function of erase counts v. time.

The attributes can include at least one of a number or percentage of memory erased, a percentage of remaining erase cycles or a percentage of erase cycles performed, an inside temperature of the solid state drive, an accumulated error rate of the solid state drive, a number of remaining reserved block count or a number of retired block count, and a value of remaining life in term of percentage of erase cycles or in term of reserved memory block.

In some embodiments, the life acceleration property can be calculated using adjusted values of the attributes, for example, the attributes are adjusted to be at a same temperature.

In some embodiments, the method can include displaying a standard value of the life acceleration property. For example, the life acceleration property can include an expected lifetime, and the time evolution graph can show the expected lifetime of the solid state drive as a function of time, e.g., the expected lifetime at different points in time. The time evolution graph can allow a user to know both the expected lifetime and the changes in expected lifetime. A standard value of expected lifetime can also be shown, allowing the user to have a standard to compare the actual expected lifetime. For example, a standard value for an expected lifetime of a solid state drive can be 5 years. The value of 5 years can be shown in the time evolution graph, which can tell the user, at a glance, about the performance of the solid state drive at different time periods. If the expected lifetime is much less than the standard value of 5 years, operating conditions might need to be evaluated to obtain at least a standard expected lifetime for the solid state drive.

In some embodiments, the method can include showing a pop-up screen at a data point of the time evolution curve, wherein the pop-up screen comprises a detail operation information of the solid state drive at the data point. A user can point a mouse at a data point, and a pop-up screen can appear, showing detail information of the operation and performance of the solid state drive at the data point.

In some embodiments, the detail operation information can include a period of data collection at the data point, an amount of memory written during the period of data collection, an amount of memory read during the period of data collection, and a remaining life of the solid state drive.

In some embodiments, the detail operation information can include a period of data collection at the data point, an amount of memory written during the period of data collection, an amount of memory read during the period of data collection, and a life expectancy of the solid state drive as operated under conditions of the period of data collection at the data point.

In some embodiments, the method can include showing a pop-up screen at a data point of the time evolution curve, wherein the pop-up screen comprises an lifetime expectancy of the solid state drive at the data point.

In some embodiments, the method can include showing a pop-up screen at a data point of the time evolution curve, wherein the pop-up screen comprises an lifetime expectancy of the solid state drive as operated under conditions of the period of data collection at the data point.

In some embodiments, the method can include comparing life acceleration properties at multiple data points of the time evolution curve.

In some embodiments, the method can include observing a life acceleration property at a current time on the time evolution curve; and then changing an aspect of the solid state drive operation to improve the life acceleration property.

In some embodiments, the method can include observing a change of a life acceleration property value in the time evolution curve; looking for the period of time when the change occurs; and tracing a cause of the change during the period of time.

FIG. 8B shows a flow chart for display a life acceleration property, such as erase count rates or remaining lifetime as a function of time. Operation 830 reads a logged data set, wherein the logged data set comprises multiple logged data collected at different times, wherein the multiple logged data comprise attributes of a solid state drive. Operation 840 displays a graph showing a life acceleration property of the solid state drive as a function of time.

In some embodiments, the life acceleration property can include a remaining lifetime of the solid state drive in unit of time, or a remaining amount of memory that can be written to the solid state drive. The life acceleration property can include a percentage of spare memory of the solid state drive. The life acceleration property can include a lifetime expectancy of the solid state drive calculated based on the instantaneous data points.

In some embodiments, the graph can include instantaneous data points of the life acceleration property. An instantaneous data point of the life acceleration property can include a life acceleration property representative of an instant or of an period of time.

In some embodiments, the present invention discloses methods and systems to calculate and show the effect of software, firmware or load on a solid state drive. A solid state drive can have flash memories, which can be degraded and replaced after a certain time in operation. For example, the operation time of a solid state drive can be directly related to a maximum number of program/erase cycles (sometimes called erase counts) of the flash memories. Different loads, firmware programs, or software programs can have different effects on the solid state drive, such as increasing or decreasing the number of program/erase cycles, which can change the operation time, e.g., the lifetime, of the solid state drive.

In some embodiments, the present invention discloses methods and systems for calculating and displaying a local instantaneous property, e.g., a property of the solid state drive based only on the instant time, or based on a certain period of time. The local instantaneous property, e.g., the calculated property on a period of time, can provide an indication of the effects of the load, firmware or software on the solid state drive. Multiple periods of time, or a long period of time can be used to calculate the local instantaneous property, if there is minimum changes, or there is no changes, on the load, firmware, software, or any other conditions. Alternatively, multiple values of a same local instantaneous property can be calculated for different periods of time, such as multiple consecutive periods of time, which can provide indications of whether or not the property is changed with respect to time. The change of the local instantaneous property can be attributed to a change in load conditions, firmware, software, operating conditions such as temperature changes, or user conditions such as different habits of loading or unloading files.

Thus, if there are changes, such as a change in a load, a firmware or a software, the local instantaneous property can be changed accordingly. For example, a local instantaneous property calculated after a change in a load, a firmware or a software can provide an indication of the effects of the new load, the new firmware or the new software. By comparing the new local instantaneous property with the previous local instantaneous property, an assessment can be formed as to the performance of the new load, the new firmware or the new software, compared to the previous load, the previous firmware or the previous software. The assessment can assist in helping improving the solid state drive, such as knowing the effect of the changes, reverting to the old conditions, or making improvements to the new load. firmware or software if the new local instantaneous property is worse.

In some embodiments, the instantaneous property, which is discussed above, can be based on a present instant or period, together with optional past periods. For example, an instantaneous rate of the consumption of the erase counts can be can be based only on the present instant or on a period of time. Thus the instantaneous rate of erase count consumption can be considered as a local instantaneous property. In contrast, an instantaneous remaining lifetime can be based on the instantaneous rate of erase count consumption, together with consumption of erase counts from the beginning of the solid state drive until the present. Thus the instantaneous remaining lifetime can be different than a local instantaneous property.

In some embodiments, the local instantaneous property can be similar to the instantaneous property that is based only on an instant or on a period of time, without relying on the past history.

In some embodiments, discloses is a process for calculating effect of software, firmware or load on a solid state drive. The solid state drive can be configured to support a load from a host system. For example, the solid state drive can be connected to the host system, and functioned as a load, e.g., a storage device, for the host system. The host system can be configured to run a software, for example, to access the solid state drive. The solid state drive can be configured to run a firmware, for example, to map the addresses provided by the host system through the software to flash memory addresses of the solid state drive. The firmware can include monitor program, such as SMART, which can calculate and store indicators of the solid state drive.

In some embodiments, local instantaneous properties can be calculated for a present period. The local instantaneous properties can provide indications or performance of the present load, firmware or software, together with possible ambient and user conditions. By comparing the present local instantaneous properties with past local instantaneous properties, changes and degrees of changes to the solid state drive can be observed.

In some embodiments, local instantaneous properties can be calculated continuously, e.g., for consecutive periods. The series of local instantaneous properties, e.g., the local instantaneous properties calculated as a function of time or index, can provide indications or performance of the solid state drive during the time in which local instantaneous properties are calculated. From the series of local instantaneous properties, changes and degrees of changes to the solid state drive can be observed, such as changes to a load, firmware or software, together with possible changes in ambient and user conditions.

In some embodiments, the calculated property can include life acceleration data, such as a number of memories that can be written to the solid state drive, or a remaining lifetime of the solid state drive. The calculated property can include life acceleration data at the operating conditions in the instant or period that the property are calculated. The calculated property can provide a feed back to a user on the way the user uses the solid state drive. For example, the calculated property can include a remaining lifetime, and by monitoring the remaining lifetime property, a user can optimize or improve the usage of the solid state drive.

In some embodiments, the calculated property can be compared with a value, such as a standard value, e.g., a rated value for the property. For example, if the calculated property is the lifetime of the solid state drive, a rated value for a lifetime of a solid state can be about 5 years. The calculated lifetime can be compared with the standard value, for example, to give a user a sense of the operation of the solid state drive as compared with standard operations.

In some embodiments, a notification can be provided to the user. For example, if the lifetime is much less than the standard value of 5 years, an alert can be sent to the user.

In some embodiments, disclosed is a process for assessing a new load, a new firmware or a new software on a solid state drive. By comparing local instantaneous properties calculated in different periods, the effect of a load, firmware or software can be evaluated. For example, after changing a load, e.g., a host system can assess the solid state drive as a storage for a different program, life acceleration parameters, such as remaining lifetime, can be calculated for a period of time with the new load. After updating a firmware on a solid state drive, life acceleration parameters, such as remaining lifetime, can be calculated for a period of time with the new firmware. After updating or changing a software on a host, e.g., the software that accesses the solid state drive as a storage medium, life acceleration parameters, such as remaining lifetime, can be calculated for a period of time with the new software. The life acceleration parameters can be calculated as to represent a characteristic of the new load, the new firmware or the new software. By comparing the life acceleration parameters on the new load, the new firmware or the new software with the life acceleration parameters calculated previously for the old load, the old firmware or the old software, an effect can be evaluated.

In some embodiments, a notification can be provided to a user. For example, if the comparison shows a significant degradation, an alert can be sent to the user.

In some embodiments, the property can be calculated from a logged data set, e.g., multiple logged data collected at different times. The logged data can include attributes of the solid state drive, such as accumulated erase counts, error rates, temperature, or lifetime.

In some embodiments, the present invention discloses methods and systems for regression testing of software or firmware for solid state drives. Programs, including firmware and software, after being developed or changed, can undergo tests, including regression testing to uncover new software bugs, or regressions, in existing functional and non-functional areas of a system. For example, a firmware can be updated or upgraded, and a regression testing can be performed before releasing.

In some embodiments, the present invention discloses methods and systems for integrating a local instantaneous property calculation in a regression test. A local instantaneous property calculation can provide information about the solid state drive at a current time, thus can generate information specifically to the new firmware or software, without being contaminated with the old firmware or software. Thus the current calculated local instantaneous property can be compared with a standard value or with a previously calculated local instantaneous property, e.g., a local instantaneous property calculated in a period of time in which the old firmware or software is running. Any degradation performance can be attributed to the new firmware or software, which can indicate poor performance. For example, a lifetime calculation can be performed for a new firmware. If the lifetime is significantly less, for example, as compared to a standard 5 year lifetime, then the performance of the new firmware might need to be improved.

In some embodiments, disclosed are methods and systems for forming time-evolution or index evolution properties for a solid state drive. A series of local instantaneous properties can be assembled to form a time evolution or index evolution of the properties. In the evolution property curves, the property at any point can be a local instantaneous property, e.g., the property within that period and not influenced by past property values.

The evolution property curves can include adjusted property values, e.g., property values corrected to be at same conditions. Properties of the solid state drive can be calculated from the evolution property curves.

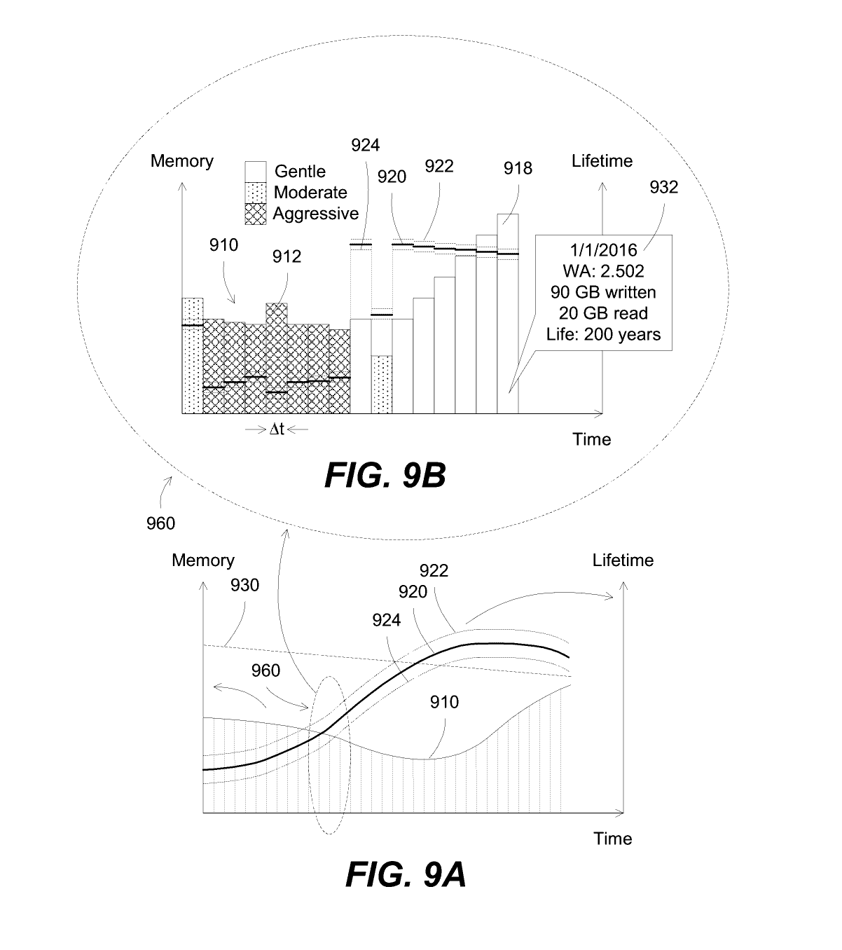

FIGS. 9A-9B illustrate a visualization of life acceleration according to some embodiments. In FIG. 9A, the values of data written to a solid state drive are displayed as a graph 910 with time. The written data can be instantaneous data, e.g., data collected during a specified time period. The remaining lifetime of the solid state drive can also be shown as a graph 920 with time. The remaining lifetime can be calculated based on the current trend of the erase count consumption, together with a past history, e.g., the amount of erase counts that already consumed. The values of remaining lifetime can be average values, e.g., calculated based on average erase count rates.

In some embodiments, best case scenario 922 and worst case scenario 924 for the remaining lifetime can be shown, together with the average values. There can be estimate or calculation errors associated with the calculation of the remaining lifetime, together with adjustments for different operating conditions such as different temperatures or different error rates. Thus best values and worst values of the remaining lifetime can be calculated and displayed, for example, to give the user a sense of confidence for the remaining lifetime calculation.

In some embodiments, standard value 930 for expected lifetime of the solid state drive can also be shown, which can give the user a tool to compare the performance of the solid state drive against the standard conditions.

In some embodiments, a new screen, an overlay screen, or a pop-up screen can be shown, for example, at pointer locations, for displaying detail information at the time or in the time period. The time or the time period can be selected by a pointer (such as a mouse or a touchpad) or by a user entering the range of time.

FIG. 9B shows a close up view for a portion 960 of the graph. The close up view can be a pop-up screen, which can be displayed when a mouse pointer points to a portion of the graph. The close up view can be screen that displays a portion of the graph using a time period inputted by a user, such as by entering a beginning and an end times, or by using a pointer indicating a time period. The close up view can show the written data bar 910 for time intervals Δt. The written data bars 912 can be characterized with life acceleration property, such as gentle, moderate or aggressive. Other pop-up screens can also be used, for example, a pop-up screen 932 showing detail information for the written data bar 918. The detail information of the time period of the written data can include the date or the time period of the written data, the write amplification factor value, the number of memory written, the number of memory read, and the lifetime of the solid state drive, such as the remaining lifetime and/or the expected lifetime.

For example, the remaining lifetime can be read from the graph, such as from remaining lifetime data point 920, together with uncertainty values 922 and 924. The detail information can include expected lifetime, e.g., the lifetime of the solid state drive that can be expected if using the operating conditions specified in the selected time period.

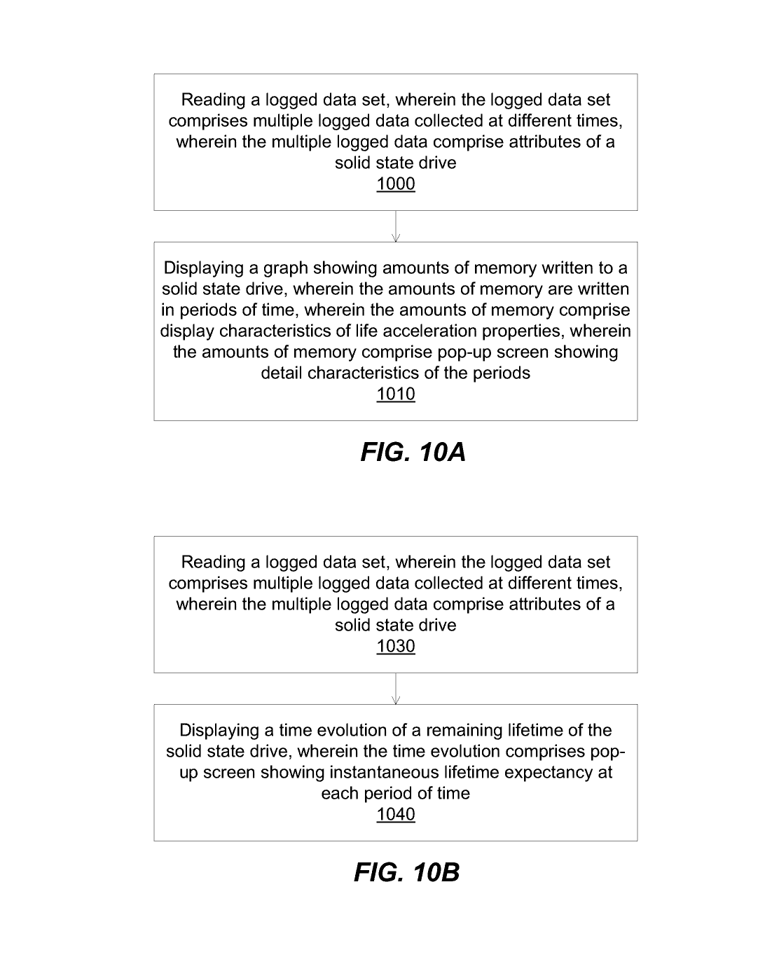

FIGS. 10A-10B illustrate flow charts for displaying life acceleration properties according to some embodiments. FIG. 10A shows a process for display graphs of written data amounts to the solid state drive, together with pop-up screen showing additional information of the solid state drive for the writing time period.

Operation 1000 reads a logged data set, wherein the logged data set comprises multiple logged data collected at different times, wherein the multiple logged data comprise attributes of a solid state drive. Operation 1010 displays a graph showing amounts of memory written to a solid state drive, wherein the amounts of memory are written in periods of time, wherein the amounts of memory comprise display characteristics of life acceleration properties, wherein the amounts of memory comprise pop-up screen showing detail characteristics of the periods.

FIG. 10B shows a process for display time evolution graphs of remaining lifetime of the solid state drive, together with pop-up screen showing additional information of the solid state drive.

Operation 1030 reads a logged data set, wherein the logged data set comprises multiple logged data collected at different times, wherein the multiple logged data comprise attributes of a solid state drive. Operation 1040 displays a time evolution of a remaining lifetime of the solid state drive, wherein the time evolution comprises pop-up screen showing instantaneous lifetime expectancy at each period of time.

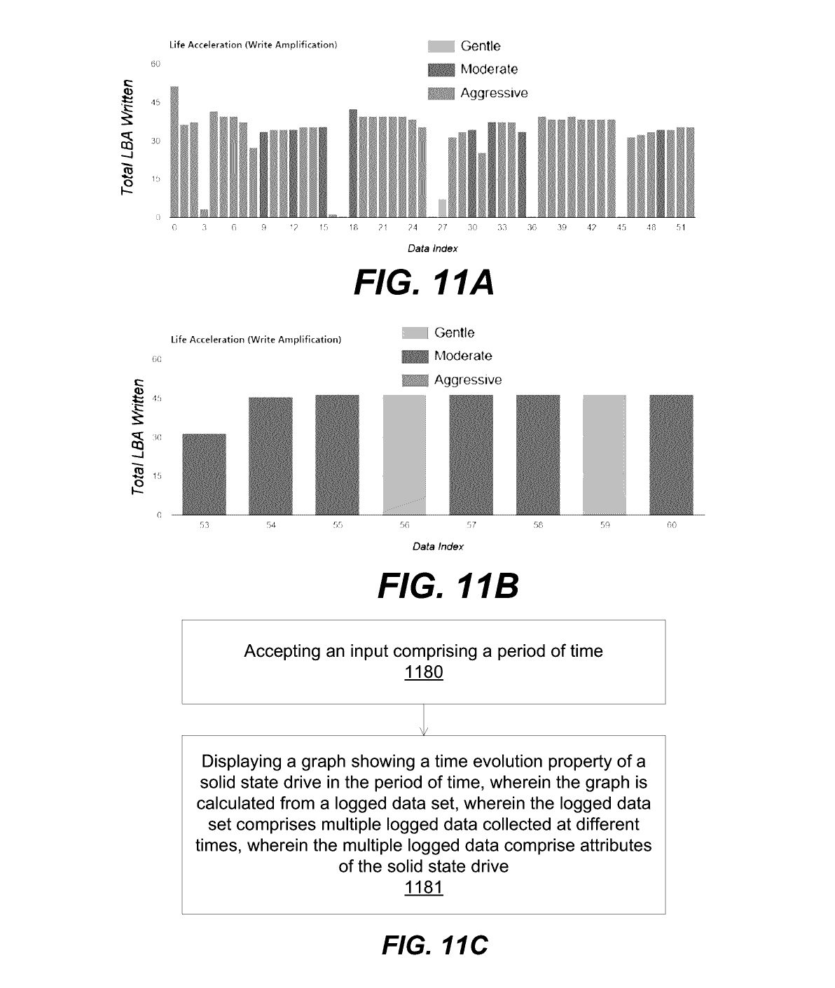

FIGS. 11A-11C illustrate a visualization of life acceleration according to some embodiments. A user can select a time period to observe the life acceleration data. A time evolution graph can be calculated, and selected portions of the graph can be displayed, for example by a user input.

In FIG. 11A, a user can select time periods 0 to 52. In FIG. 11B, a user can select time periods 53 to 60. Values of written data can shown for these time periods, together with characteristics of the writing process, e.g., life acceleration data for writing these data. For example, a writing process with long lifetime, such as having a low write amplification factor, can be characterized as gentle writing, e.g., having a higher than standard expected lifetime. A writing process with standard lifetime, such as having a standard write amplification factor, can be characterized as moderate writing, e.g., having a standard expected lifetime. A writing process with short lifetime, such as having a high write amplification factor, can be characterized as aggressive writing, e.g., having a lower than standard expected lifetime.

FIG. 11C shows a flow chart for displaying life acceleration data for selected time periods. Operation 1180 accepts an input which can include a period of time, such as a beginning time and an end time. Operation 1181 displays a graph showing a time evolution property of a solid state drive in the period of time, wherein the graph is calculated from a logged data set, wherein the logged data set comprises multiple logged data collected at different times, wherein the multiple logged data comprise attributes of the solid state drive.

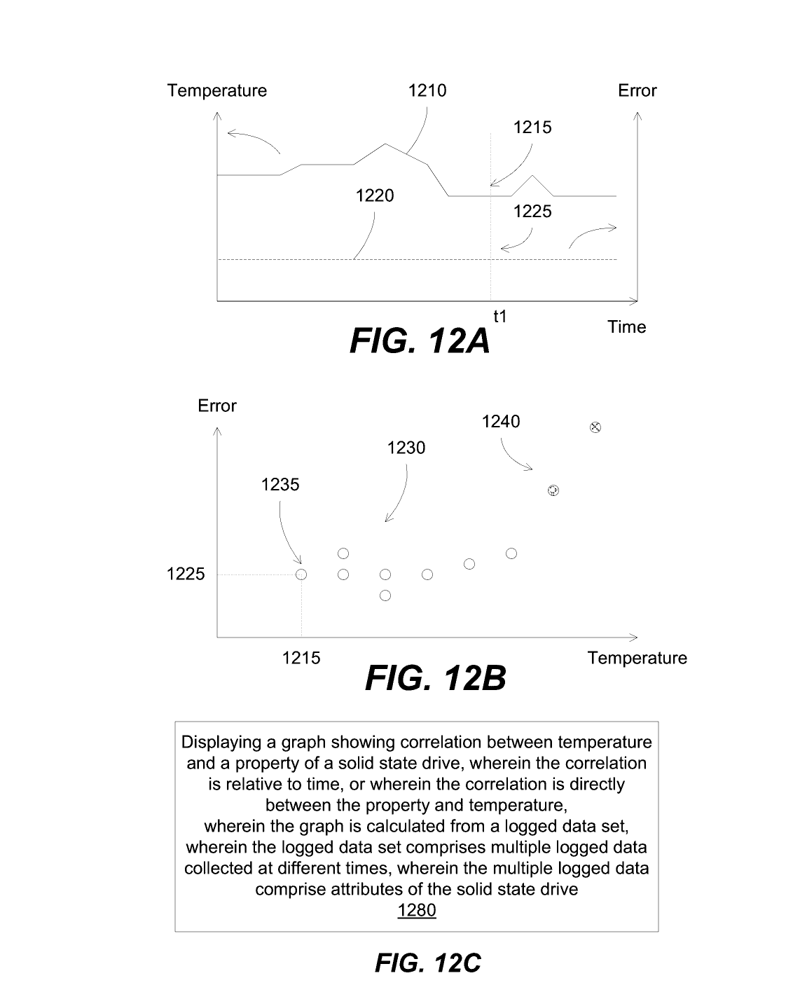

FIGS. 12A-12C illustrate relationships between attributes of a solid state drive according to some embodiments.

In some embodiments, the present invention discloses methods and systems to form correlations or relationships between the characteristics, e.g., attributes collected by a firmware such as SMART program, of a solid state drive. The relationships can provide information about the interdependency of the characteristics, or the effects of one characteristic on another characteristic, such as error rates of the solid state drive as a function of operating temperature. The relationships can allow property calculation compensation, for example, by correcting or adjusting the characteristics for a same calculation condition. For example, the logged data set, which includes multiple logged data, with each logged data collected at a different time, can include data at different temperatures. Each logged data can include multiple characteristics (or attributes or indicators or parameters, which can be used interchangeably in the present specification), of the solid state drive, together with the time that the characteristics are logged. The relationships between the characteristics and the operating temperature can allow a correction or adjustment of the characteristics to a same temperature, which then can ensure that the data used in the property calculation are at a same temperature.

In some embodiments, the relationships can be formed between various characteristics, attributes or parameters of a solid state drive. The relationships can be between characteristics or attributes of the solid state drive, such as the effects of temperature, program/erase cycles, reserved or spare memory on the performance, error rates, or remaining lifetime. For example, the performance, the error rates, and the remaining lifetime can be formulated as a function of the operating temperature of the solid state drive. The program/erase cycles can be formulated as a function of the error rates. The program/erase cycles can be formulated as a function of the reserved or spare memory.

The relationship can be formed based on the data collected and recorded at different times, e.g., the multiple logged data in a logged data set. For example, a SMART monitoring program can collect attributes such as read error rates, write error rates, number or percentage of program/erase cycles, wear leveling characteristics, operating temperature, etc. Logged data at different logged times can be recorded, which can be used to provide cross relationships between these attributes.

In some embodiments, the relationships can be formed between different properties, e.g., data calculated from the attributes, and between properties and attributes. For example, a remaining lifetime can be an attribute, e.g., calculated and stored by a firmware such as SMART. The remaining lifetime attribute can be an average value, e.g., calculated from the usage of program/erase cycles for the total time of operation of the solid state drive. The remaining lifetime attribute can have error, especially if there are large changes to the operating conditions of the solid state drive. For example, during the first year, the solid state drive might not be used much, so there is a low consumption of program/erase cycles. During the second year, the solid state drive might be used extensively, so there is a high consumption of program/erase cycles. The remaining lifetime attribute can be calculated using the average of high and low consumption of program/erase cycles per year. Thus the value of the remaining lifetime attribute can be greatly over-estimated if the solid state drive is continued to be used extensively.

In contrast, attributes from the logged data set can be used to calculate an instantaneous remaining lifetime, which can be considered a calculated property of the solid state drive. The remaining lifetime property, e.g., the remaining lifetime calculated from other attributes in the logged data set, can be more accurate than the remaining lifetime attribute, e.g., the remaining lifetime values present in the logged data set, since it reflects an instantaneous value, instead of a time average value.

In some embodiments, a relationship can be obtained between two characteristics, such as attributes generated from SMART process. The relationships can be determined from 2 points, e.g., a rate of change can be calculated from the 2 points, and data can be interpolated or extrapolated from the rate of change, e.g., the rate of change can be constant. For example, a first collected data at a first time can include a first error rate and a first operating temperature. A second collected data at a second time can include a second error rate and a second operating temperature. A rate of change of the error rate can be calculated as a ratio of the difference between the first and second error rates over the difference between the first and second temperatures. A third error rate value at a third temperature can be obtained from the rate of change of the error rate, e.g., the rate of change between the first and third data points can be the same as the rate of change between the first and second data points.

A first value of a first attribute and a first value of a second attribute can be obtained at a first time data collection of a solid state drive, e.g., first values for the first and second attributes can be obtained from the logged data of the first time. For example, a first attribute can be the program/erase cycles y. A second attribute can be the write error rate x. From a first logged data, e.g., logged data obtained at the first time, a first value y₁ of 30% and a first value x₁ of 2% can be obtained for the first logged data.

A second value of the first attribute and a second value of the second attribute can be obtained at a second time data collection. For example, for a second logged data, a second value y₂ of 33% (for the first attribute of program/erase cycles) and a second value x₂ of 4% (for the second attribute of write error rate) can be obtained for the second logged data.

An effect of the first attribute on the second attribute can be calculated. The effect can be a relationship between the first and second attributes. For example, the first attribute can be formulated as a function of the second attribute. In the above example, the relationship between the program/erase cycle y and the write error rate x can be formulated as

$$\frac{x - {x}_{1}}{y - {y}_{1}} = \frac{{x}_{2} - {x}_{1}}{{y}_{2} - {y}_{1}}$$

The relationships can be determined from more than 2 points, e.g., a curve fitting can be calculated from the multiple data points, and data can be calculated from the fitted curve. For example, a first collected data at a first time can include a first error rate and a first operating temperature. A second collected data at a second time can include a second error rate and a second operating temperature. A third collected data at a third time can include a third error rate and a third operating temperature. The first, second, and third temperatures can all be different temperatures, or some of them can be the same temperature.

A fitted curve of the error rate can be calculated as a curve fitting for the three data points of error rates and temperatures. For example, a linear regression fitting can provide a fitted curve for the three data points. Error rates at other temperatures can be determined from the fitted curve.

FIGS. 12A and 12B show relationships of a characteristic of a solid state drive, such as an error rate, e.g., read error, write error, or link error, with the operating temperature. In FIG. 12A, temperatures and error rates can be shown as functions of time, e.g., graphs of a temperature curve 1210 and an error rate curve 1220 v. times can be displayed. The temperature and the error rates can be read from the logged data set, e.g., each logged data can include an operating temperature, an error rate, and the time that the temperature and the error rate are logged.

In FIG. 12B, the error rates can be displayed as a function of temperature. For example, at time t1, a temperature 1215 and an error rate 1225 can be obtained from either the logged data set, or from the graphs of temperature and error rate v. time. The temperature 1215 and error rate 1225 can form a data point 1235 for a error rate-temperature graph. The data points of temperature and error rate can be displayed as a point-to-point graphs. In addition, the data points can be curve fitted to form a fitted curve, e.g., a relationship between error rate and temperature of the solid state drive.

There can be multiple error rate values for one temperature value, for example, due to the changes of the error rates or due to other operating conditions of the solid state drive. Thus, a fitted curve can be used, for example, to obtain a relationship having minimum deviations.

At low temperatures, e.g., at around room temperature of lower than about 30 C, the error rate values can be constant, except for the deviations. At acceptable high temperatures, such as from 35 C to a maximum operating temperature of about 60 to 80 C, the error rate values can be constant or can be slightly increased, together with possible deviations. At moderately high temperatures, such as from 60 C to about 100 C or so, the error rate values can increase. At these temperature regime 1230, the solid state drive can operate normally.

At a high temperature regime 1240, e.g., at temperatures above a few hundred degrees, the error rates might increase rapidly, and the solid state drive might experience early failure.

In some embodiments, the relationships can be determined from 2 points, e.g., a linear relationship between the 2 points. The relationships can be determined from more than 2 points, e.g., a curve fitting can be calculated from the multiple data points, and data can be calculated from the fitted curve.

The above description describes relationships between error rates, such as read error rate, write error rate, recovered hardware error correcting code (ECC), or UDMA CRC error count (SATA link error), and temperature. However, the present invention is not limited to relationships between error rates and temperature. Relationships between other characteristics of the solid state drive with temperature can be used, such as erase count, erase count rate v. temperature. Further, relationships between two different characteristics of the solid state drive can also be used, such as relationship between erase count rate and error rate.

FIG. 12C shows a flow chart for displaying a relationship between a characteristic of a solid state drive and its operating temperature. Operation 1280 displays a graph showing correlation between temperature and a property of a solid state drive, wherein the correlation is relative to time, or wherein the correlation is directly between the property and temperature, wherein the graph is calculated from a logged data set, wherein the logged data set comprises multiple logged data collected at different times, wherein the multiple logged data comprise attributes of the solid state drive.

In some embodiments, the present invention discloses methods and systems for calculate properties for a solid state drive under similar conditions. Data, e.g., characteristics of a solid state drive, can be recorded at different times, e.g., forming a logged data set, which can allow the calculation of the solid state drive properties, such as instantaneous properties and property values in unit of time. The recording conditions can be different at the different recording times, for example, the operating temperature can change from one recorded time to another recorded time.

In some embodiments, the recorded data, e.g., the characteristics in the logged data set, can be adjusted or corrected to compensate for the changes in the recorded conditions. For example, a first logged data in a logged data set can be recorded at a first temperature. The recorded temperature can be stored in the logged data as an attribute of the logged data. A second logged data in the logged data set can be recorded at a second temperature. If the first and second temperatures are not the same, properties calculated from the attributes in the logged data set can be somewhat inconsistent, since the attributes are recorded at different temperatures.

In some embodiments, the inconsistent data can be removed from the logged data set. For example, first, second, fourth and fifth logged data can be recorded at a same temperature, and third logged data can be recorded at a different temperature. The third logged data can be removed from the calculation of properties of the solid state drive, thus providing property values for the recorded temperature.

In some embodiments, the logged data set can be ordered into multiple logged data subsets, with each logged data subsets having a same operating temperature. A property of the solid state drive can be calculated based on a logged data subset, allowing the property to be calculated at a same temperature. Different values of a same property can be calculated for different temperatures, e.g., using different logged data subsets, which can generate best case scenario, e.g., property calculated for a lowest temperature, worst case scenario, e.g., property calculated for a highest temperature, average case scenario, e.g., property calculated for an average temperature or property calculated as an average of the various case scenarios.

In some embodiments, the logged data set can be adjusted to be at a same temperature. For example, the logged data set can include values of program/erase cycle collected at different times, and possibly at different temperatures. A relationship of the program/erase cycle and temperature can be determined, for example, from a linear proportion calculation based on 2 data points, or from a fitted curve based on a multiple data point curve fitting. The relationship can be used to adjust the values of program/erase cycles in the logged data set to be values of program/erase cycles at the desired temperature.

For example, a logged data at a first recorded time can include a value of program/erase cycle and an operating temperature. Thus the value of program/erase cycle for the first recorded time are obtained at the recorded operating temperature. This value of program/erase cycle can be adjusted to be at a different temperature by using the relationship of program/erase cycle and temperature. Using the relationship, values of program/erase cycle in different recorded times, e.g., in different recorded temperature, can be adjusted to be at a same temperature. A property of the solid state drive, e.g., the remaining lifetime, can be calculated using adjusted values of program/erase cycle, e.g., using values of program/erase cycle at different recorded times that are adjusted to a same temperature.

Multiple values of the property, such as multiple values of remaining lifetime, can be calculated for different temperatures. An average value of the remaining lifetime can be calculated from these multiple values. Also, best case and worst case scenarios can be obtained, e.g., best and worst remaining lifetime can be determined, for example, by using data at lowest and highest temperature, respectively.

In some embodiments, logged data from different recorded times are obtained, and then adjusted to be at a same condition. The adjusted values can be used to calculate a property of the solid state drive. For example, a first value of a first attribute and a first value of a second attribute can be obtained at a first collected time of a solid state drive. For example, the first attribute can be program/erase cycle, and the second attribute can be remaining reserve or remaining spare memory blocks. A first value of program/erase cycle and a first value of remaining reserve memory blocks can be obtained from the logged data collected at the first recorded time.

A second value of the first attribute and a second value of the second attribute can be obtained at a collected time. A second value of program/erase cycle and a second value of remaining reserve memory blocks can be obtained from the logged data collected at the second recorded time.

The first or second value of the first attribute can be adjusted to correspond to the second or first value of the second attribute, respectively. If the first and second values of remaining reserve memory blocks are different, the first value of the program/erase cycle can be adjusted to reflect the value of program/erase cycle at the second value of remaining reserve memory blocks. Alternatively, the second value of the program/erase cycle can be adjusted to reflect the value of program/erase cycle at the first value of remaining reserve memory blocks.

In some embodiments, the logged data set can be adjusted to be at the highest or lowest temperature. High temperature operation can shorten the lifetime of electronic devices, thus worst case scenario can be estimated by using the highest operating temperature of the solid state drive. Similarly, best case scenario can be estimated using the lowest operating temperature.

In some embodiments, a relationship linking the program/erase cycle with the remaining reserve memory blocks can be calculated from the logged data set. The relationship can be used to adjust the values of the program/erase cycle as discussed above.

A property of the solid state drive can be calculated using the values of the first attribute at a same value of the second attribute. For example, the first value and the adjusted second value of the first attribute can be used to calculate a property of the solid state drive at the first value of the second attribute. The adjusted first value and the second value of the first attribute can be used to calculate a property of the solid state drive at the second value of the second attribute.

Data from a logged data set can be obtained, and then adjusted to be at a same temperature. The temperature adjusted values can be used to calculate a property of the solid state drive, such as a remaining lifetime.

A relationship between an attribute and temperature can be obtained. The relationship can be calculated from the logged data set, for example, by a linear calculation using 2 data points, or by a curve fitting for the attribute values and the temperature values in the logged data set.

Values of the attributes and corresponding temperatures of a solid state drive can be obtained. The values of the attributes and the corresponding temperatures can be obtained from the logged data set, e.g., each value of the attribute and the corresponding temperature can be obtained from a logged data of the logged data set.

The values of the attributes can be adjusted to be at a same temperature. For example, a desired temperature can be determined, and the values of the attributes for the logged data set can be adjusted to be at the desired temperature using the relationship. Different sets of values can be generated for different temperatures. Different property values can be calculated from the different sets of values.

In some embodiments, the present invention discloses systems and methods for allow a user to know the performance of a solid state drive at a glance. A graphic summary can be used to display the performance of the solid state drive, which can be shown in one or more pages. The graphic summary can provide the user with knowledge about the operation and performance of the solid state drive, at least in term of life acceleration characteristics, e.g., factors that can affect the lifetime of the solid state drive. With the knowledge, the user can make changes, such as usage and operation changes, to improve the lifetime performance of the solid state drive.

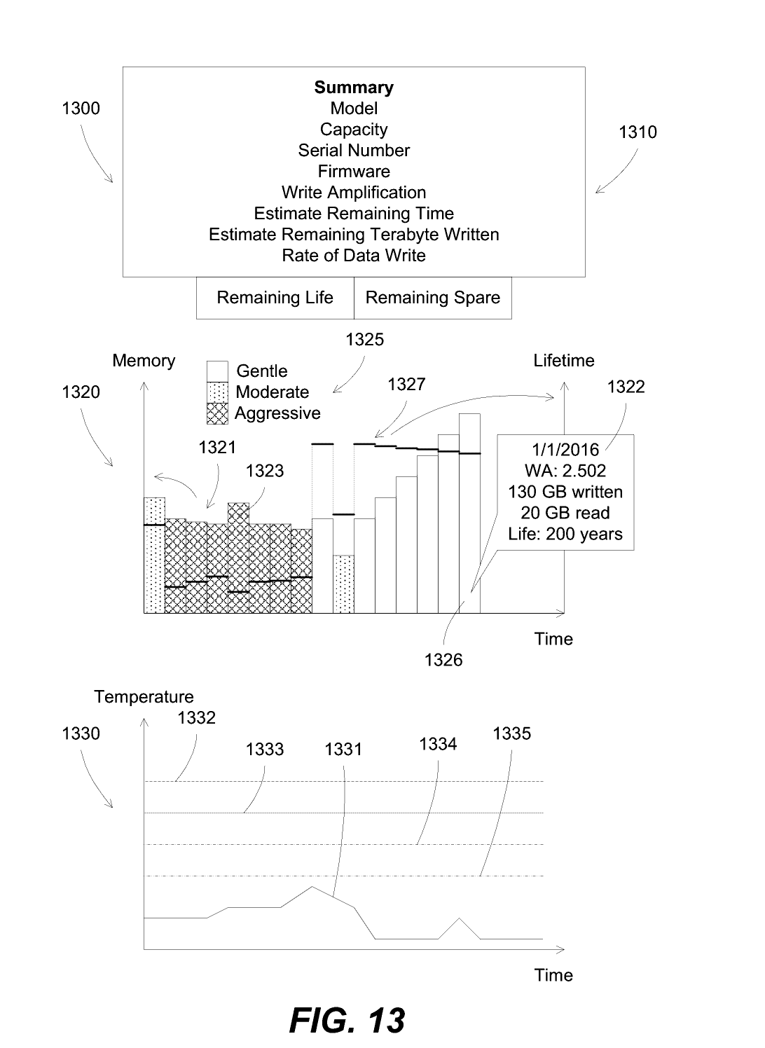

FIG. 13 illustrates a graphic summary of a solid state drive according to some embodiments. The graphic summary 1300 can include a listing summary 1310 to provide a summary of the solid state drive, which can include information related to the solid state drive, such as model number, capacity, serial number, and firmware version. The listing summary can include a write amplification factor, such as an average value or an instantaneous value. The listing summary can include an estimated remaining lifetime of the solid state drive, in time unit and/or in memory unit. For example, the remaining lifetime can be 324 years, or 1500 TB. The summary can include a rate of data write, e.g., how fast or slow the data is written to the solid state drive. The listing summary can include a percentage remaining lifetime and remaining spare of the solid state drive. For example, for a new solid state drive, the remaining lifetime can be 100%, and the remaining spare can also be 100%.

The graphic summary can include a display 1320 of a graph 1321 of amounts of written data to the solid state drive, together with an indication 1323 of a performance of the solid state drive for the written data. For example, the display can include a graph showing the amount of data written to the solid state drive as a function of time. Further, the data points of the written data can be shown with one of multiple writing characteristics 1325, e.g., indicators to show how the data is written to the solid state drive, in term of life acceleration, e.g., the data is written with high lifetime expectancy (such as gentle writing with low write amplification factors or low erase count rates), the data is written with medium or standard lifetime expectancy (such as moderate writing with standard write amplification factors or standard erase count rates), and the data is written with low lifetime expectancy (such as aggressive writing with high write amplification factors or high erase count rates). The writing characteristics of the written data can provide a time evolution of the solid state drive, indicating when the drive is written with good, average, or bad life acceleration performance. The time evolution performance can assist a user in identifying issues and problems with the solid state drive operation, leading to solutions for improving the solid state drive operation, such as changing a workload, changing a firmware, changing a software, or changing a way of using the solid state drive.

The display can include a graph 1327 of remaining lifetime, e.g., how much longer the solid state can be in operation, projecting from current and the past usages. The remaining lifetime can be displayed in unit of time, e.g., in months or years, in unit of written data, e.g., in GigaBytes or TeraBytes, or in unit of percentage of the total life of the solid state drive.

In some embodiments, best and worst remaining lifetime can also be shown, calculated based on calculation errors or deviations, or based on data adjusted for best or worst temperature ranges.

In some embodiments, standard values for properties of the sold state drive can also be shown, for example, to allow a user to compare the actual performance of the solid state drive with standard values, such as values designed and estimated by the manufacturers. For example, a standard remaining lifetime can be shown, which, when compared with the calculated remaining lifetime, can provide the user with indication of the solid state performance.

The time axis of the display can be adjusted, for example, from an input of a user, such as by using a pointer or by entering a time range. This can allow the user to select any time period to observe the performance and operation of the solid state drive.

Pop-up screens 1322 can also be shown, for example, when a pointer points to a data point 1326, such as at a time interval or time period, or at an amount of written data point. The pop-up screens can include detail information of the data point 1326, include the time or time period of the data point, the write amplification factor, the amount of written data, the amount of read data, and lifetime, such as an expected lifetime using the operating conditions of the data point 1326.

The graphic summary can include a display 1330 of temperature graphs, e.g., graphs of various characteristics of the solid state drive with temperature. The graphs can be plotted as a function of time, together with temperature. For example, a temperature graph 1331 can be displayed, showing the operating temperature for different times. Other characteristics can be displayed, such as a graph 1332 of the write workload, e.g., the amount of written data to the solid state drive, a graph 1333 of the read workload, e.g., the amount of data read from the solid state drive, a graph 1334 of the recovered hardware ECC error, and a graph 1335 of the UDMA CRC error count. Other characteristics can also be shown, such as erase count rates.

In some embodiments, the present invention discloses methods for visualizing the operation of a solid state drive, including showing graphs of important characteristics. The method can include reading a logged data set, wherein the logged data set comprises multiple logged data collected at different times, wherein the multiple logged data comprise attributes of a solid state drive; and displaying properties of the solid state drive, wherein the properties include a visual description of remaining lifetime, a visual description of read and write workloads, a visual description of an impact on the solid state drive based on a usage of the solid state drive, and a visual description of correlations between operating temperatures of the solid state drive and operation errors of the solid state drive.

The method can further include calculating the properties using the logged data set. The properties can be calculated based on a curve fitting of the attributes of the solid state drive. The properties can be calculated using adjusted values of the attributes, wherein the adjusted values are adjusted to be at a same temperature. The properties can be displayed as a function of time. The properties can include properties representative of an instant or of an period of time.

The attributes can include a number or percentage of memory erased, a percentage of remaining erase cycles or a percentage of erase cycles performed, an inside temperature of the solid state drive, an accumulated error rate of the solid state drive, a number of remaining reserved block count or a number of retired block count, an accumulated number of memory read or memory written, a value of remaining life in term of percentage of erase cycles or in term of reserved memory block.

In some embodiments, the method can include displaying a standard value for a remaining lifetime for the solid state drive, and comparing the visual description of remaining lifetime with the standard value. The method can include using the displayed data as a guide to improve or optimize the operation of the solid state drive, such as changing a working habit, changing a workload, changing a firmware, or changing a software. The method can include showing a pop-up screen at a data point of the graph, wherein the pop-up screen comprises a detail operation information of the solid state drive at the data point. The method can include showing a pop-up screen at a data point of the display, wherein the pop-up screen comprises an lifetime expectancy of the solid state drive as operated under conditions of the period of data collection at the data point.

The detail operation information comprises a period of data collection at the data point, an amount of memory written during the period of data collection, an amount of memory read during the period of data collection, and a remaining life of the solid state drive. The detail operation information comprises a period of data collection at the data point, an amount of memory written during the period of data collection, an amount of memory read during the period of data collection, and a life expectancy of the solid state drive as operated under conditions of the period of data collection at the data point.

In some embodiments, the graphic summary can include other information, such as custom information set-up by the user.

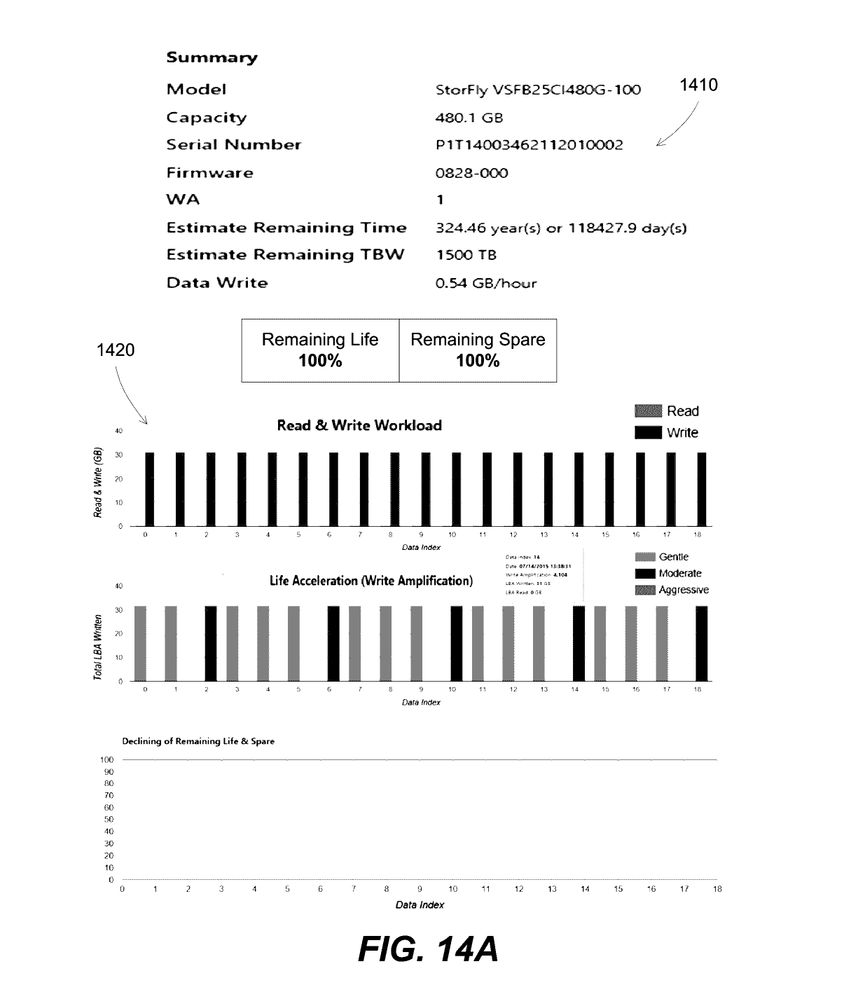

FIGS. 14A-14B illustrate an example of a graphic summary according to some embodiments. In FIG. 14A, a listing summary 1410 can include information related to the solid state drive. A display 1420 can include graphs of data written to and read from the solid state drive, together with a graph showing the decline of the remaining lifetime and spare. The written data can include a characteristic of life acceleration, such as the write amplification factor, showing the effect of the writing process on the solid state drive.

In FIG. 14B, graphs 1430 of information related to temperature can be shown, including written data, read data, and error rate information, such as hardware ECC error and UDMA CRC error counts.

In some embodiments, provided is a machine readable storage, having stored there on a computer program having a plurality of code sections for causing a machine to perform the various steps and/or implement the components and/or structures disclosed herein. In some embodiments, the present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, a nonvolatile electronic memory, or the like. The software program may be run on a variety of devices, e.g. a processor.

In some embodiments, the methods can be realized in hardware, software, or a combination of hardware and software. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

The terms “computer program”, “software”, “application”, variants and/or combinations thereof, in the context of the present specification, mean any expression, in any language, code or notation, of a set of instructions intended to cause a system having an information processing capability to perform a particular function either directly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system, such as a general purpose computer system. A general purpose computer system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen (not shown), can be substituted for the mouse. This general purpose computer may be one of the many types well known in the art, such as a mainframe computer, a minicomputer, a workstation, or a personal computer.

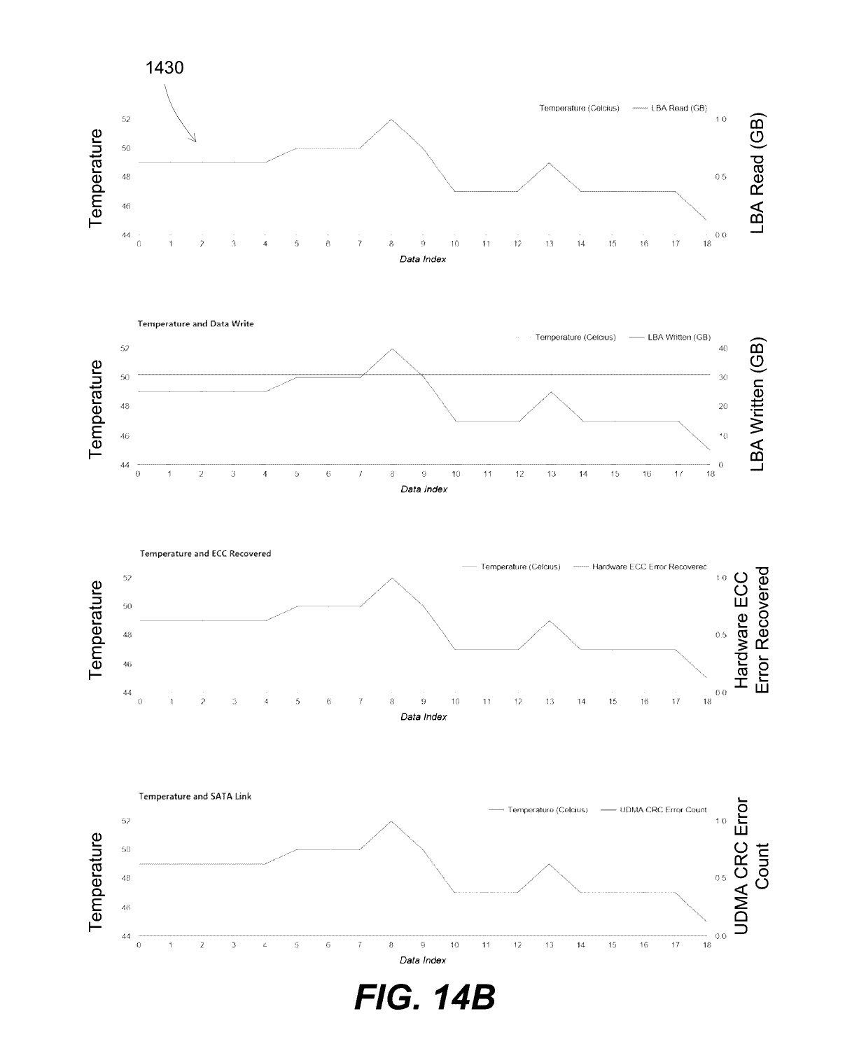

FIG. 15 illustrates a computing environment according to some embodiments. An exemplary environment for implementing various aspects of the invention includes a computer 2001, comprising a processing unit 2031, a system memory 2032, and a system bus 2030. The processing unit 2031 can be any of various available processors, such as single microprocessor, dual microprocessors or other multi-processes or architectures. The system bus 2030 can be any type of bus structures or architectures, such as 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCSI).

The system memory 2032 can include volatile memory 2033 and nonvolatile memory 2034. Nonvolatile memory 2034 can include read only memory (ROM), programmable ROM (PROM), electrically programmable ROM (EPROM), electrically erasable ROM (EEPROM), or flash memory. Volatile memory 2033, can include random access memory (RAM), synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), or direct Rambus RAM (DRRAM).

Computer 2001 also includes storage media 2036, such as removable/nonremovable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 2035 can be used to facilitate connection. These storage devices can be considered as part of the I/O device 2038 or at least they can be connected via the bus 2030. Storage devices that are “on board” generally include EEPROM used to store the BIOS.

The computer system 2001 further can include software to operate in the environment, such as an operating system 2011, system applications 2012, program modules 2013 and program data 2014, which are stored either in system memory 2032 or on disk storage 2036. Various operating systems or combinations of operating systems can be used.

Input devices can be used to enter commands or data, and can include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 2038. Interface ports 2038 can include a serial port, a parallel port, a game port, a universal serial bus (USB), and a 1394 bus. The interface ports 2038 can also accommodate output devices 2021. For example, a USB port may be used to provide input to computer 2001 and to output information from computer 2001 to an output device 2021. Output adapter 2039, such as video or sound cards, is provided to connect to some output devices such as monitors, speakers, and printers.

Computer 2001 can operate in a networked environment with remote computers. The remote computers, including a memory storage device, can be a personal computer, a server, a router, a network PC, a workstation, a microprocessor based appliance, a peer device or other common network node and the like, and typically includes many or all of the elements described relative to computer 2001. Remote computers can be connected to computer 2001 through a network interface 2035 and communication connection 2037, with wire or wireless connections. Network interface 2035 can be communication networks such as local-area networks (LAN), wide area networks (WAN) or wireless connection networks. LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

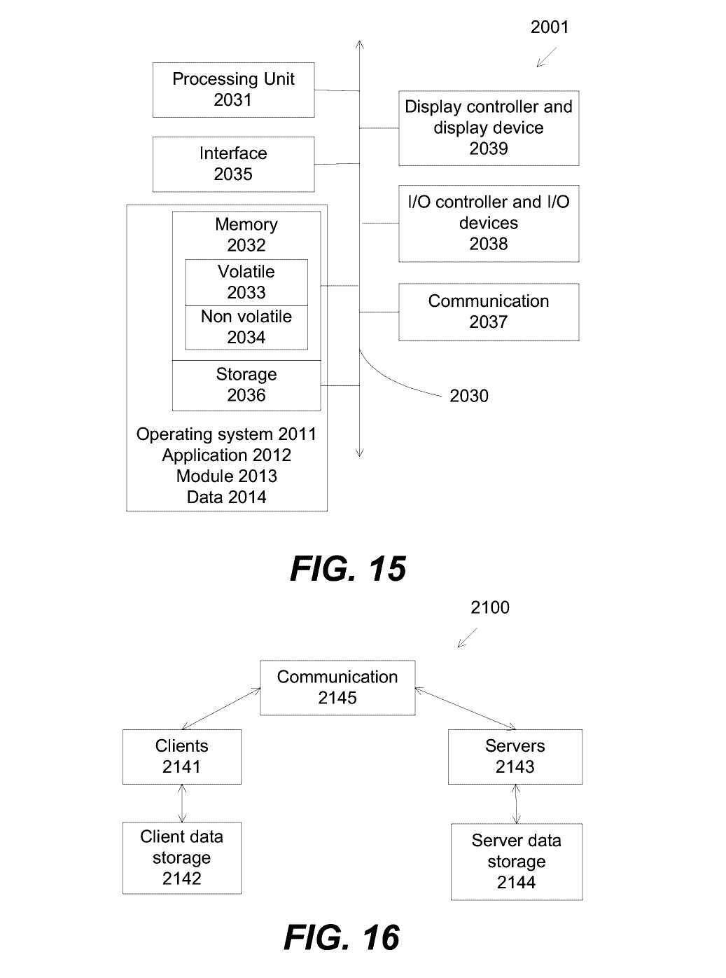

FIG. 16 is a schematic block diagram of a sample computing environment with which the present invention can interact. The system 2100 includes a plurality of client systems 2141. The system 2100 also includes a plurality of servers 2143. The servers 2143 can be used to employ the present invention. The system 2100 includes a communication network 2145 to facilitate communications between the clients 2141 and the servers 2143. Client data storage 2142, connected to client system 2141, can store information locally. Similarly, the server 2143 can include server data storages 2144.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method comprising
reading a logged data set, wherein the logged data set comprises multiple logged data collected at different times, wherein the multiple logged data comprise attributes of a solid state drive;
displaying a time evolution curve of a life acceleration property of the solid state drive, wherein the time evolution curve shows the life acceleration property at different times.

2. A method as in claim 1
wherein the life acceleration property comprises an instantaneous property.

3. A method as in claim 1 further comprising
displaying a standard value of the life acceleration property.

4. A method as in claim 1 further comprising
showing a pop-up screen at a data point of the time evolution curve, wherein the pop-up screen comprises an lifetime expectancy of the solid state drive at the data point.

5. A method comprising
reading a logged data set, wherein the logged data set comprises multiple logged data recorded at different times, wherein the multiple logged data comprise attributes of a solid state drive and a recording time of the multiple logged data;
displaying a graph showing a life acceleration property of the solid state drive as a function of time, wherein the graph comprises instantaneous data points of the life acceleration property.

6. A method as in claim 5 further comprising
calculating the life acceleration property using the logged data set.

7. A method as in claim 5
wherein the life acceleration property is calculated based on a curve fitting of the attributes of the solid state drive.

8. A method as in claim 5
wherein the life acceleration property is calculated using adjusted values of the attributes, wherein the adjusted values are adjusted to be at a same temperature.

9. A method as in claim 5
wherein the life acceleration property comprises at least one of
a remaining lifetime of the solid state drive in unit of time,
a remaining amount of memory that can be written to the solid state drive, and
a percentage of spare memory of the solid state drive.

10. A method as in claim 5 further comprising
displaying a standard value of the property.

11. A method as in claim 5 further comprising
showing a pop-up screen at a data point of the graph, wherein the pop-up screen comprises a detail operation information of the solid state drive at the data point.

12. A method as in claim 5
wherein the a detail operation information comprises at least one of
a period of data collection at the data point,
an amount of memory written during the period of data collection,
an amount of memory read during the period of data collection,
a remaining life of the solid state drive, and
a life expectancy of the solid state drive as operated under conditions of the period of data collection at the data point.

13. A method as in claim 5 further comprising
comparing life acceleration properties at multiple data points on the graph.

14. A method as in claim 5 further comprising
observing a property at a current time on the graph;
changing an aspect of the solid state drive operation to improve the life acceleration property.

15. A method as in claim 5 further comprising
observing a change of a life acceleration property value in the graph;
looking for the period of time when the change occurs;
tracing a cause of the change during the period of time.

16. A method comprising
reading a logged data set, wherein the logged data set comprises multiple logged data collected at different times, wherein the multiple logged data comprise attributes of a solid state drive;
displaying properties of the solid state drive, wherein the properties include a visual description of remaining lifetime, a visual description of read and write workloads, a visual description of an impact on the solid state drive based on a usage of the solid state drive, and a visual description of correlations between operating temperatures of the solid state drive and operation errors of the solid state drive.

17. A method as in claim 16
wherein the properties are displayed as a function of time.

18. A method as in claim 1 further comprising
displaying a standard value for a remaining lifetime for the solid state drive,
comparing the visual description of remaining lifetime with the standard value.

19. A method as in claim 16 further comprising
showing a pop-up screen at a data point of the graph, wherein the pop-up screen comprises a detail operation information of the solid state drive at the data point.

20. A method as in claim 16
wherein the detail operation information comprises a period of data collection at the data point, an amount of memory written during the period of data collection, an amount of memory read during the period of data collection, and at least one of a remaining life of the solid state drive and a life expectancy of the solid state drive as operated under conditions of the period of data collection at the data point.
